(19) United States
(12) Patent Application Publication
(10) Pub. No.: US 2025/0175953 A1
(43) Pub. Date: May 29, 2025

(54) Technique for Feedback Communication on a Sidelink

(71) Applicant: Telefonaktiebolaget LM Ericsson (publ), Stockholm (SE)

(72) Inventors: Hieu Do, Järfälla (SE); Ricardo Blasco Serrano, Espoo (FI); Shehzad Ali Ashraf, Munich (DE); Jose Angel Leon Calvo, Munich (DE)

(21) Appl. No.: 18/841,913

(22) PCT Filed: Mar. 8, 2023
(86) PCT No.: PCT/EP2023/055895

§ 371 Date: Aug. 27, 2024

Related U.S. Application Data
(60) Provisional application No. 63/318,483, filed on Mar. 10, 2022.

(51) Int. Cl. H04W 72/0446; H04W 16/14; H04W 72/25

(52) U.S. Cl. CPC H04W 72/0446; H04W 16/14; H04W 72/25

(57) ABSTRACT

A technique for transmitting a feedback message on a sidelink, SL, from a first wireless device (100; 1300; 1591; 1592; 1630) to a second wireless device (200; 1400; 1591; 1592; 1630) is described. As to a method aspect of the technique, responsive to a first time resource (602) for data reception, a feedback message is transmitted (304) using a second time resource (604) out of at least two time resource candidates (606) of a feedback channel from the first wireless device (100; 1300; 1591; 1592; 1630) to the second wireless device (200; 1400; 1591; 1592; 1630) on the SL. The at least two time resource candidates (606) are associated to the first time resource (602) according to a temporal relation (608) between the first time resource (602) and each of the time resource candidates (606). The at least two time resource candidates (606) comprise time resources of the feedback channel that include a predefined number of K time resources of the feedback channel, wherein K>1 is an integer. An indicator associated with the data and/or indicated by SL control information, SCI, scheduling the data reception is indicative of the parameter K.

### TECHNICAL FIELD

The present disclosure relates to a technique for feedback communication on a sidelink. More specifically, and without limitation, methods and devices are provided for transmitting and receiving a feedback message on a sidelink between wireless devices.

### BACKGROUND

A sidelink (SL) is a wireless interface and a wireless link used for direct wireless communication between wireless devices, also referred to as device-to-device (D2D) communications. This is in contrast to typical cellular communications in which two wireless devices communicate by means of uplink (UL) and downlink (DL) transmissions through a radio access network (RAN). The sidelink interface is sometimes referred to as PC5 interface. The interface for UL and DL is sometimes referred to as Uu interface.

The Third Generation Partnership Project (3GPP) defined SLs in Release 12 as an adaptation of the Long Term Evolution (LTE) radio access technology for direct communication between two radio devices, also referred to as user equipment (UE), without going through a base station. Such device-to-device (D2D) communications through SLs are also referred to as proximity service (ProSe), which includes communication and discovery. The SL can be used for Public Safety communications. While conventional public safety communications use different standards in different geographical regions and countries, 3GPP SL communications enable interworking of different public safety groups. 3GPP has enriched SLs in Release 13 for public safety and commercial communication use-cases and, in Release 14, for vehicle-to-vehicle (V2V) and vehicle-to-everything (V2X) scenarios. Support was enhanced during Release 15. From the point of view of the lowest radio layers, the LTE SL uses broadcast communication. That is, transmission from a UE targets any receiver that is in range.

In Release 16, 3GPP introduced the SL for the radio access technology (RAT) of fifth generation (5G) new radio (NR). A driving use case were vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver.

Both the LTE SL and the NR SL can operate with and without network coverage and with varying degrees of interaction between the UEs and the RAN, including support for standalone or network-less operation of the SL.

In the current NR SL design, a SL resource pool can be configured with dedicated radio resources for feedback transmissions on a physical sidelink control channel (PSFCH), which occur at every N-th slot and which are also referred to as PSFCH occasions.

Together with a constraints set by a processing delay, the timing relation between a PSSCH transmission and its associated PSFCH occasion is deterministic (i.e., one-to-one). Patent application WO 2022/073010 A1 discloses a method of SL transmission and a Channel Access (CA) operation for a hybrid automatic repeat request (HARQ) feedback transmission in a second slot for the SL transmission.

However, when operating the SL in unlicensed spectrum (SL-U), even if dedicated PSFCH occasions are configured from the SL-U perspective, there is no guarantee that such PSFCH occasions can always be used by the SL-U devices, because the radio resources might have been occupied by non-SL-U transmissions such as Wi-Fi transmissions of another wireless device.

If a PSFCH occasion cannot be used for PSFCH transmissions, some changes to the NR SL hybrid automatic repeat request (HARQ) feedback design are needed. One straightforward solution would be dropping all PSFCH transmissions which could have been sent if the PSFCH occasion had been available. Nevertheless, such an approach is undesirable, since discarding many HARQ feedback messages at once can negatively affect the network performance.

Furthermore, when a SL-U UE is receiving from more than one peer SL-U UE, the receiving SL-U UE can be placed in a situation when the SL-U UE has to decide which one of the peer SL-U UEs is provided with a feedback while the other peer SL-U UE cannot be responded to.

### SUMMARY

Accordingly, there is a need for a technique for feedback communication on a sidelink that can handle situation involving multiple wireless devices.

As to a first method aspect, a method performed by a first wireless device for transmitting a feedback message on a sidelink (SL) to a second wireless device is provided. The method comprises, responsive to a first time resource for data reception, transmitting a feedback message using a second time resource out of at least two time resource candidates of a feedback channel from the first wireless device to the second wireless device on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data, and/or indicated by SL control information (SCI) scheduling the data reception, is indicative of the parameter K.

The first method aspect may be performed by the first wireless device, optionally a (e.g., data) receiving wireless device and/or a feedback-transmitting wireless device.

By virtue of the temporal relation that associates the at least two time resource candidates with the first time resource for the data reception (e.g., at the first wireless device) or data transmission (e.g., at the second wireless device), the first wireless device has the opportunity to retry a channel access (e.g., in unlicensed spectrum) for the second time resource or to respond to a further second wireless device (e.g., when receiving from more than one peer wireless device).

The feedback message may be transmitted in response to the (e.g., attempted) data reception. The second time resource may be after the first time resource. Alternatively or in addition, a time difference between the second time resource and the first time resource may be less than a limit defined by the temporal relation.

The feedback message may be indicative of whether or not the data was (e.g., successfully) received and/or decoded in the first time resource for the data reception. For example, the feedback may be based on a cyclic redundancy check (CRC) value included in a code block or transport block of the data.

Each of the at least two time resource candidates may be associated to the first time resource for the data reception (i.e., the first time resource of the data reception or the attempted data reception) by virtue of the temporal relation. Alternatively or in addition, the method may comprise determining the at least two time resource candidates as a function of the first time resource for the data reception (i.e., the first time resource of the data reception or the attempted data reception). In other words, the temporal relation may define the at least two time resource candidates based on the first time resource.

The data may comprise at least one of user data, a (e.g., common or dedicated) control message, a radio link control (RLC) message, and a non-access stratum (NAS) message. Alternatively or in addition, the data may comprise data of Intelligent Transport Systems (ITS). For example, the data may comprise at least one of a Cooperative Awareness Messages (CAM), a Decentralized Environmental Notification Messages (DENM), and Basic Safety Message (BSM). Alternatively or in addition, the first and second wireless devices may be any pair of vehicle, pedestrian, and (e.g., road) infrastructure.

The data may be received in one or more data packets (or briefly: packets). Alternatively or in addition, the first wireless device may be referred to as a receiving wireless device (or briefly: receiver or RX). The second wireless device may be referred to as a transmitting wireless device (or briefly: transmitter or TX), e.g., according to a direction of transmitting the data. Each of the first and second wireless device may be a user equipment (UE) configured for operation of SLs, which may be referred to as SL UE. The first and second wireless devices may be referred to as RX UE and TX UE.

The method (e.g., according to the first method aspect) may further comprise for the data reception a step of receiving (or attempting to receive) the data in the first time resource of a data channel from the second wireless device at the first wireless device on the SL.

The receiving (or reception) of the data may also be referred to as the data reception. Alternatively or in addition, the attempting (or attempt) to receive the data may also be referred to as the attempt of the data reception or the attempted data reception. Alternatively or in addition, the step of receiving the data or attempting to receive the data may be referred to as the (attempted) data reception.

The feedback message (e.g., according to the first method aspect) may be indicative of at least one of an acknowledgement (ACK) of the data; a negative acknowledgement (NACK) of the data; and a hybrid automatic repeat request, HARQ, feedback for the data.

The transmitting of the feedback message (e.g., according to the first method aspect) may further comprise determining the second time resource out of the at least two time resource candidates.

The first wireless device may determine (e.g., select) a single one of the at least two time resource candidates as the second time resource for the transmission of the feedback message.

The transmitting of the feedback message (e.g., according to the first method aspect) may comprise transmitting the feedback message multiple times using multiple second time resources out of the at least two time resource candidates.

The second time resource (e.g., according to the first method aspect) may be determined out of the at least two time resource candidates and/or a number of the one or multiple second time resources is used for the transmitting of the feedback message one or multiple times. The determining of the second time resource and/or the number of the one or multiple second time resources may be dependent on one or a combination of: a priority of the data or a service underlying the data; the SL between the first wireless device and the second wireless device or the pair of the first wireless device and the second wireless device; the first time resource or the time when the data is received or attempted to be received; the second wireless device from which the data is received or attempted to be received; a remaining time of a packet delay budget (PDB) of the data or a service underlying the data; and a number of remaining time resource candidates that are associated with the first time resource.

The earlier second time resource candidate may be selected out of the at least two time resource candidates for the transmission of the feedback if the priority is greater (e.g., than a predefined threshold or greater than another priority of another feedback pending for transmission), and/or if a predefined time has elapsed since the data has been received and/or if the feedback has been pending longer than another feedback that is pending for transmission and/or if a remaining time of a PDB of the data (or a service underlying the data) is less than a predefined threshold or if the remaining time of the PDB is less than a remaining time of another PDB of another data reception and/or if a number of remaining time resource candidates that are associated with the first time resource is less than a predefined threshold and/or if the number of the remaining time resource candidates is less than a number of remaining time resource candidates that are associated with another first time resource of another data reception.

The priority may be associated with the data or a service underlying the data. For example, the priority may correspond to a service type of the service or a quality of service (QOS) required for the data. Alternatively or in addition, the priority may depend on a remaining (i.e., residual) time of a packet delay budget (PDB) of the data. Alternatively or in addition, the second time resource may be determined out of the at least two time resource candidates in fulfillment of the PDB. For example, if the remaining time of the PDB is greater than threshold time, the second time resource may be the second or the latest one of at least two time resource candidates. If the residual time of the PDB is equal to or less than the threshold time, the second time resource may be the first one of at least two time resource candidates. The threshold time may correspond to, or may include, a portion of the PDB for the SL.

For example, the transmitting of the feedback message may comprise transmitting the feedback message multiple times using multiple second time resources out of the at least two time resource candidates if the data is associated with a high priority, e.g. if the data is associated with an ultra-reliable low-latency communication (URLLC).

The method (e.g., according to the first method aspect) may further comprise (or receiving or attempting to receive the data may comprise) at least one of: receiving or attempting to receive first data in an earlier first time resource and second data in a later first time resource of the data channel; receiving or attempting to receive first data in a first frequency resource and second data in a second frequency resource of the data channel; receiving or attempting to receive first data and second data, wherein the priority of the first data is greater than the priority of the second data; and receiving or attempting to receive first data from the second wireless device and second data from a further second wireless device.

Any of the above alternatives may or may not be combined. For example, the first data and second data may be received or attempted to be received in the first and second frequency resources, respectively, in the same first time resource or in the earlier and later first time resources, respectively. Alternatively or in addition, the first data and second data may be received or attempted to be received in the first and second frequency resources, respectively, from the second wireless device and the further second wireless device, respectively. While above alternative refer to “first data” and “second data” without article, in the case of a combination, the first data and the second data may be used with the definite article at second occurrence.

Herein, the later first time resource may be later than the earlier first time resource. Alternatively or in addition, the first frequency resource may be different from the second frequency resource.

The first data may be received or attempted to be received from the second wireless device on the SL, and the second data may be received or attempted to be received from the further second wireless device on a further SL. The first wireless device may be configured with a resource pool for the SL between the first wireless device and the second wireless device, and with a further resource pool for the further SL between the first wireless device and the further second wireless device.

Each of the respective first time resources for the first and second data may be associated with the same at least two time resource candidates according to the temporal relation (e.g., according to the first method aspect). The transmitting of the feedback message may comprise transmitting a first feedback message for the first data in an earlier second time resource out of the at least two time resource candidates and transmitting a second feedback message for the second data in a later second time resource out of the at least two time resource candidates.

Herein, the later second time resource may be later than the earlier second time resource.

Each of the respective first time resources being associated with the same at least two time resource candidates according to the temporal relation may mean that the at least two time resource candidates for the first and second data fully overlap or are identical. For example, each of the earlier first time resource and the later first time resource may be associated with the same at least two time resource candidates according to the temporal relation because the earlier first time resource and the later first time resource are sufficiently close in time. Alternatively or in addition, each of the respective first time resources may be associated with the same at least two time resource candidates according to the temporal relation because the first time resources are identical (e.g., the same slots).

A temporal order (i.e., a chronological order) of the feedback transmissions may be reversed relative to a temporal order of the corresponding (attempted) data receptions. For example, the first feedback message may be transmitted in the earlier second time resource and the second feedback message may be transmitted in the later second time resource because the priority of the first data is greater than the priority of the second data, e.g., even if the first data is received or attempted to be received in a later first time resource and the second data is received or attempted to be received in an earlier first time resource of the data channel.

The first feedback message may be transmitted using the first frequency resource and/or to the second wireless device. The second feedback message may be transmitted using the second frequency resource and/or to the further second wireless device.

Each of the respective first time resources for the first and second data may be associated with at least one common time resource candidate out of the respective at least two time resource candidates according to the temporal relation (e.g., according to the first method aspect). The transmitting of the feedback message may comprise transmitting in the common time resource candidate the feedback message for either the first data or the second data depending on which one has the fewer number of remaining time resource candidates after the common time resource candidate out of the respective at least two time resource candidates.

Each of the respective first time resources for the first and second data being associated with at least one common time resource candidate out of the respective at least two time resource candidates may mean that the at least two time resource candidates for the first and second data at least partially overlap, wherein the overlap is referred to as the at least one common time resource candidate.

For example, the feedback message for the first data may be still pending at the common time resource candidate, because the CCA for an earlier time resource candidate out of the at least two time resource candidates associated with the first time resource failed (i.e., indicated that the earlier time resource candidate was occupied.)

The receiving or attempting to receive the data (e.g., according to the first method aspect) may comprise receiving or attempting to receive first data in an earlier first time resource and second data in a later first time resource of the data channel. The priority of the second data may be greater than the priority of the first data.

A temporal order (i.e. a chronological order) of the (attempted) data receptions may correspond to a temporal order of the corresponding feedback transmissions. For example, the first time resource may correspond to the priority (e.g., so that the priority associated with the earlier first time resource is greater than the priority associated with the later first time resource).

Each of the earlier first time resource and the later first time resource may be associated with the at least two time resource candidates according to the temporal relation (e.g., according to the first method aspect). The transmitting of the feedback message comprises transmitting a second feedback message for the second data in an earlier second time resource out of the at least two time resource candidates and transmitting a first feedback message for the first data in a later second time resource out of the at least two time resource candidates.

A temporal order of the (attempted) data receptions and a temporal order of the corresponding feedback transmissions may be different in order to fulfill the priority. For example, the priority may overrule the temporal order of the (attempted) data receptions.

At least one of the SL, the receiving of the data or the attempting to receive the data, and the transmitting of the feedback message may use radio spectrum shared by multiple radio access technologies (RATs).

The transmitting (e.g., according to the first method aspect) of the feedback message may comprise sensing if the feedback channel is available at an earlier time resource candidate out of the at least two time resource candidates. The feedback message may be transmitted using the earlier time resource candidate as the second time resource if a result of the sensing is indicative of the feedback channel being available at the earlier time resource candidate. Alternatively or in addition, the feedback message may be transmitted using a later time resource candidate as the second time resource out of the at least two time resource candidates if a result of the sensing may be indicative of the feedback channel being not available at the earlier time resource candidate.

Transmitting the feedback message using the later time resource candidate as the second time resource may comprise further sensing if the feedback channel is available at the later time resource candidate out of the at least two time resource candidates. The feedback message may be transmitted using the later time resource candidate as the second time resource if a result of the further sensing is indicative of the feedback channel being available at the later time resource candidate.

The sensing (e.g., according to the first method aspect) may be based on decoding and/or detecting sidelink control information (SCI) from the second wireless device or a third wireless device to determine if the feedback channel is available at the earlier time resource candidate.

For example, if there is an SCI (e.g., based on the decoding and/or from any wireless device configured for communication on the SL, e.g. any SL-U UE) in that slot, the earlier time resource candidate (e.g., the respective slot) is considered occupied (by SL and/or shared by the second or third wireless device). Hence, the feedback channel (e.g., one or more PSFCH symbols configured at the end of the earlier time resource candidate, e.g., at the end of the respective slot) is available for the first wireless device (e.g., as for any wireless device configured for communication on the SL which has a feedback message to transmit). Alternatively or in addition, the SCI may be or may comprise a booking message, e.g. for the earlier time resource candidate. The result of the sensing may be indicative of the feedback channel being available or not available at the earlier time resource candidate according to an indication in the booking message for the earlier time resource candidate and/or for the feedback channel.

The first wireless device may perform the sensing based on decoding and/or detecting sidelink control information (SCI) from the second wireless device (e.g., as a peer wireless device) to determine if the feedback channel (i.e., radio resources of the feedback channel) in the earlier second time resource (e.g., PSFCH resources) is (or are) available.

The sensing based on decoding and/or detecting may comprise at least one of the following features or steps. By configuration, the feedback channel (e.g., PSFCH symbols) may comprise few dedicated OFDM symbols at the end of the respective (e.g., earlier or later) second time resource (e.g., the respective PSFCH slot). Alternatively or in addition, if the first wireless device (e.g., the RX UE) detects an SCI in the respective first time resource (e.g., the respective slot), the first wireless device deduces that the first time resource (e.g., the respective slot) is occupied by the second wireless device (e.g., a peer SL UE). Hence, the feedback channel at the respective second time resource (e.g., the PSFCH symbols in the respective slot), e.g., at the end of the respective second time resource (e.g., the respective slot) are available to use, because the transmitting of the data from the second wireless device (i.e., the receiving of the data at the first wireless device) will end before the feedback channel (e.g., the PSFCH symbols) in the respective second time resource. Alternatively or in addition, a channel occupancy time (COT, also referred to as channel access time) may be shared between the first and second wireless devices, e.g., as indicated above. Alternatively or in addition, the second wireless device may (e.g., implicit or explicitly) share the COT initiated by transmitting the data in the first radio resource with other wireless devices (e.g., UEs) that want to transmit their feedback messages on their feedback channels (e.g., PSFCHs).

The further sensing may be based on decoding and/or detecting SCI from the second wireless device or a third wireless device to determine if the feedback channel is available at the later second time resource.

The sensing (e.g., according to the first method aspect) may comprise performing a clear channel assessment (CCA) of the feedback channel for an earlier second time resource out of the at least two time resource candidates.

The CCA may be part of a listen-before-talk (LBT) procedure. Alternatively or in addition, the LBT procedure may comprise a random backoff mechanism. For example, the first wireless device may comprise a backoff timer that is initiated by a random time duration (e.g., within a contention window, which may have a fixed or variable size). The backoff timer is reduced if or while the respective second time resource is unoccupied (e.g., after a successful CCA). The feedback message is transmitted if the backoff timer expires prior to or at the time of the feedback channel in the respective second time resource.

Transmitting the feedback message using the later second time resource may comprise performing a further CCA for the later second time resource.

The at least two time resource candidates (e.g., according to the first method aspect) may be a subset of a set of time resources of the feedback channel. Alternatively or in addition, the at least two time resource candidates are consecutive time resources in a set of time resources of the feedback channel.

The set of time resources of the feedback channel (e.g., according to the first method aspect) may comprise periodically occurring time resources with a periodicity N in units of a length of each time resource. Alternatively or in addition, every N-th time resource of the SL may be a time resource of the feedback channel, wherein N is an integer equal to 1 or greater than 1.

Being a time resource of the feedback channel may or may not exclude that the respective time resource is also a time resource of another channel (e.g., the data channel). For example, the feedback channel may be multiplexed with the other channel in the frequency domain and/or the code domain and/or the time domain (e.g., by using different symbols for different physical channels in the same slot). The respective time resource (e.g., a slot) may comprise a plurality of symbols. A subset of the symbols in one time resource may be allocated to the feedback channel, while another subset of the symbols in the same time resource is allocated to another channel.

The at least two time resource candidates associated to the first time resource according to the temporal relation (e.g., according to the first method aspect) may comprise time resources of the feedback channel that are at least a predefined duration TP later than the first time resource and/or that are at most a predefined time Tₘₐₓ later than the first time resource. Alternatively or in addition, the K time resources of the feedback channel are K consecutive time resources of the feedback channel.

The time resources of the feedback channel being at least the predefined duration TP later than the first time resource may mean that the at least two time resource candidates may be among the time resources immediately following TP 1 after the first time resource.

For example, Tₘₐₓ may be equal to Tₚ+N·K, i.e., the at least two time resource candidates may be among the Tₚ+N·K−1 time resources immediately following the first time resource.

Each of the at least two time resource candidates (e.g., according to the first method aspect) may be associated to the first time resource according to the temporal relation if at least one of the respective time resource candidate is a time resource of the feedback channel that is at least a predefined duration TP later than the first time resource; and the respective time resource candidate is a time resource of the feedback channel that is at most a predefined time Tₘₐₓ later than the first time resource, optionally wherein Tₘₐₓ=Tₚ+T for T>0.

Herein, the relation described by the expression “associated to” may be bidirectional. That is, stating the time resource is associated to (e.g., each of) the at least two time resource candidates may be equivalent to stating that (e.g., each of) the at least two time resource candidates is associated to the first time resource.

The time resources of the feedback channel being at least the predefined duration Tₚ later than the first time resource may mean that the at least two time resource candidates may be among the time resources immediately following Tₚ−1 after the first time resource.

For example, Tₘₐₓ may be equal to Tₚ+T, i.e., each of the at least two time resource candidates may be among the Tₚ+T−1 time resources immediately following the first time resource. T may be equal to N·K or, the T may be different from N·K.

The method (e.g., according to the first method aspect) may further comprise determining a configuration and/or receiving a configuration message indicative of a configuration from a radio access network (RAN), or from a network node serving the first wireless device or from the second wireless device. The configuration being indicative of at least one of the first time resource for receiving or attempting to receive the data, optionally in SL control information (SCI); a set of the time resources of the feedback channel, optionally a periodicity of a physical SL feedback channel (PSFCH); the parameter N of the set of the time resources of the feedback channel; the temporal relation; the parameter Tₘₐₓ of the temporal relation; the parameter Tₚ of the temporal relation; the parameter T of the temporal relation; the parameter K of the temporal relation; and a resource pool of the SL, optionally the resource pool comprising the first time resource for the receiving or the attempting to receive the data and the set of the time resources of the feedback channel.

The parameter T may be a time span time comprising resource candidates of the feedback channel (e.g., PSFCH occasions) or the parameter K may be the number of time resource candidates of the feedback channel (e.g., PSFCH occasions) which can be used for the feedback message in response to (e.g., positively or negatively acknowledging) the data reception (e.g., a PSSCH reception).

The configuration (e.g., according to the first method aspect), optionally the parameter K and/or the parameter T, may depend on or may be determined by at least one of an interference condition to the SL, optionally an interference condition at the first wireless device and/or at the second wireless device; a quality of service (QOS) an interference condition, a latency requirement or a packet delay budget (PDB) of the data or a service using the SL; a numerology to be used on the SL; an upper bound of the number of physical resource blocks (PRBs) available for the feedback channel; a priority associated with the data or a service using the SL; a resource pool or a resource pool configuration of the SL; contents of the data.

The indicator may be the priority. The priority may be associated with the data and/or indicated by the SCI scheduling the data reception. The priority may be indicative of the parameter K and/or the parameter T. Alternatively or in addition, an upper bound of the parameter K and/or the parameter T may be predefined per resource pool. The indicator may be indicative of the parameter K and/or the parameter T provided that the indicated value may be less than or equal to the predefined upper bound.

Herein, “predefined” may encompass configured (e.g., by a network node) or hardcoded or encoded in hardware or software (e.g., specified according to a technical standard) or preconfigured (e.g., stored in a subscriber identity module, SIM).

A receiver value of the parameter K and/or the parameter T, or an upper bound thereof, may be predefined per resource pool at the first wireless device (e.g., according to the first method aspect). Alternatively or in addition, a transmitter value of the parameter K and/or the parameter T may be related to contents of the data and/or may be known at the second wireless device and/or may be unknown at the first wireless device. The second wireless device may retransmit the data upon expiry of transmitter value. Alternatively or in addition, the transmitter value may be equal to or less than the receiver value.

Frequency resources at the second time resource in the feedback channel (optionally one or more physical resource blocks, PRBs) that are used for the transmitting of the feedback message may be dependent on the first time resource (e.g., according to the first method aspect). Alternatively or in addition, non-overlapping sets of time resources of the data channel for the first time resource may be mapped to different frequency resources at the second time resource in the feedback channel, optionally one or more physical resource blocks (PRBs) used for the transmitting of the feedback message.

Different codes, optionally different values of cyclic shifts and/or cyclic shift pairs, may be used for the transmitting of the feedback message at the second time resource in the feedback channel depending on the first time resource and/or depending on the second time resource out of at least two time resource candidates (e.g., according to the first method aspect).

The feedback channel on the SL may be a physical SL feedback channel (PSFCH). Alternatively or in addition, the data channel may be a physical SL shared channel (PSSCH). Alternatively or in addition, the second time resource may be a slot (optionally a slot of a or the PSFCH). Alternatively or in addition, the earlier and the later second time resources may be earlier and later slots, respectively (optionally earlier and later slots, respectively, of a or the PSFCH). Alternatively or in addition, the at least two time resource candidates of a feedback channel or any time resources of the feedback channel may be slots (optionally slots of a or the PSFCH). Alternatively or in addition, the feedback channel may comprise in the respective second time resource and/or in each of the at least two time resource candidates one or two or few symbols, optionally consecutive symbols at the end of the respective second time resource and/or the end of each of the at least two time resource candidates. Alternatively or in addition, the first time resource for receiving (or attempting to receive) the data may be a first slot used for receiving or attempting to receive the data. Alternatively or in addition, the second time resource used for the transmitting of the feedback message may be a second slot used for the transmitting of the feedback message. Alternatively or in addition, the at least two time resource candidates of a feedback channel may be at least two slot candidates of a feedback channel.

The earlier and later time resource candidates may be earlier and later slots, respectively. Alternatively or in addition, the slots of the PSFCH may also be referred to as PSFCH slots or PSFCH occasions. Alternatively or in addition, the length of each time resource may be a slot length.

The consecutive symbols of the feedback channel (e.g. PSFCH symbols) may be at the end of the respective second time resource and/or at the end of each of the at least two time resource candidates up to an empty symbol or a guard period, e.g., for switching between downlink (DL) and uplink (UL) in time-division duplexing.

As to a second method aspect, a method performed by a second wireless device for receiving a feedback message on a sidelink (SL) from a first wireless device is provided. The method comprises responsive to a data transmission using a first time resource, receiving a feedback message in a second time resource out of at least two time resource candidates of a feedback channel from the first wireless device at the second wireless device on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The second method aspect may be performed by the second wireless device, optionally a (e.g., data) transmitting wireless device or a feedback-receiving wireless device.

The second method aspect may further comprise any feature and/or any step disclosed in the context of the first method aspect, or a feature and/or step corresponding thereto, e.g., a receiver counterpart to a transmitter feature or step.

The receiving of the feedback message may comprise monitoring (e.g., and decoding or attempting to decode) each of the at least two time resource candidates for the feedback message. The time resource candidate in which the feedback message is (e.g., successfully) received (e.g., received first) may be referred to as the second time resource.

The method (e.g., according to the second method aspect) may further comprise, for the data transmission transmitting the data, using the first time resource of a data channel on the SL from the second wireless device to the first wireless device.

As to another aspect, a computer program product is provided. The computer program product comprises program code portions for performing any one of the steps of the first method aspect or the second method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a first wireless device for transmitting a feedback message on a sidelink (SL) to a second wireless device is provided. The first wireless device comprising memory operable to store instructions and processing circuitry operable to execute the instructions, such that the first wireless device is operable to responsive to a first time resource for data reception, transmit a feedback message using a second time resource out of at least two time resource candidates of a feedback channel from the first wireless device to the second wireless device on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The first wireless device (e.g., according to the first device aspect) may be further operable to perform any one of the steps of the first method aspect.

As to another first device aspect, a first wireless device for transmitting a feedback message on a sidelink (SL) to a second wireless device is provided. The first wireless device being configured to responsive to a first time resource for data reception, transmit a feedback message using a second time resource out of at least two time resource candidates of a feedback channel from the first wireless device to the second wireless device on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The first wireless device (e.g., according to the first device aspect) may further configured to perform any one of the steps of the first method aspect.

The device of the other first device aspect may be configured to perform any one of the steps of the first method aspect. As to a first device aspect, the device comprises processing circuitry (e.g., at least one processor and a memory). Said memory comprises instructions executable by said at least one processor whereby the device is operative to perform any one of the steps of the first method aspect.

As to another first device aspect, a receiving user equipment (UE), for transmitting a feedback message on a sidelink (SL) to a transmitting UE is provided. The receiving UE being configured to communicate with a base station and/or a peer UE. The receiving UE comprising a radio interface and processing circuitry configured to responsive to a first time resource for data reception, transmit a feedback message using a second time resource out of at least two time resource candidates of a feedback channel from the receiving UE to the transmitting UE on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The receiving UE (e.g., according to the first device aspect), wherein the processing circuitry may be further configured to execute any one of the steps of the first method aspect.

As to a second device aspect, a second wireless device for receiving a feedback message on a sidelink (SL) from a first wireless device is provided. The second wireless device comprising memory operable to store instructions and processing circuitry operable to execute the instructions, such that the second wireless device is operable to responsive to a data transmission using a first time resource, receive a feedback message in a second time resource out of at least two time resource candidates of a feedback channel from the first wireless device at the second wireless device on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The second wireless device (e.g., according to the second device aspect) may be further operable to perform any one of the steps of the second method aspect.

As to another second device aspect, a second wireless device for receiving a feedback message on a sidelink (SL) from a first wireless device is provided. The second wireless device being configured to responsive to a data transmission using a first time resource, receive a feedback message in a second time resource out of at least two time resource candidates of a feedback channel from the first wireless device at the second wireless device on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The second wireless device (e.g., according to the second device aspect) may further configured to perform any one of the steps of the second method aspect.

The device of the other second device aspect may be configured to perform any one of the steps of the second method aspect. As to the second device aspect, the device comprises processing circuitry (e.g., at least one processor and a memory). Said memory comprises instructions executable by said at least one processor whereby the device is operative to perform any one of the steps of the second method aspect.

As to another second device aspect, a transmitting user equipment (UE) for receiving a feedback message on a sidelink (SL) from a receiving UE is provided. The transmitting UE being configured to communicate with a base station and/or a peer UE. The transmitting UE comprising a radio interface and processing circuitry configured to responsive to a data transmission using a first time resource, receive a feedback message in a second time resource out of at least two time resource candidates of a feedback channel from the receiving UE at the transmitting UE on the SL. The at least two time resource candidates are associated to the first time resource according to a temporal relation between the first time resource and each of the time resource candidates. The at least two time resource candidates comprise time resources of the feedback channel that include a predefined number of K time resources of the feedback channel, wherein K>1 is an integer. An indicator associated with the data and/or indicated by SL control information (SCI) scheduling the data reception is indicative of the parameter K.

The processing circuitry of the transmitting UE (e.g., according to the other second device aspect) may be further configured to execute any one of the steps of the second method aspect.

As to a system aspect, a communication system including a host computer is provided. The communication system comprises processing circuitry configured to provide user data; and a communication interface configured to forward user data to a cellular or ad hoc radio network for transmission to a transmitting or receiving user equipment (UE). The UE comprises a radio interface and processing circuitry, the processing circuitry of the UE being configured to execute any one of the steps of the first method aspect and/or the second method aspect.

The communication system (e.g., according to the system aspect) may further including at least one of the transmitting and receiving UE.

The radio network (e.g., according to the system aspect) may further comprise a base station, or a radio device functioning as a gateway, which is configured to communicate with the transmitting or receiving UE.

The base station, or the radio device functioning as a gateway (e.g., according to the system aspect) may comprise processing circuitry, which is configured to control or configure any one of the steps of the first method aspect or the second method aspect.

The communication system (e.g., according to the system aspect) wherein the processing circuitry of the host computer may be configured to execute a host application, thereby providing the user data; and the processing circuitry of the UE may be configured to execute a client application associated with the host application.

In any aspect, the technique may comprise a mechanism that allows a data transmission (e.g., on a physical SL shared channel, PSSCH) to be potentially acknowledged in multiple consecutive feedback occasions (e.g., physical SL feedback channel, PSFCH, occasions) as the at least two time resource candidates.

The feedback message may be a hybrid automatic repeat request (HARQ) feedback (HARQ FB).

If the HARQ FB cannot be transmitted in the first of the time resource candidates (e.g., the first PSFCH occasion), e.g., due to a failed channel access, one or more subsequent time resource candidates (e.g., PSFCH occasions) can be used.

Alternatively or in addition, at least some embodiments of the technique can provide the at least two time resource candidates and/or one or more unambiguous rules to determine the temporal (or timing) relation (or relationship) between the second time resource (e.g., a PSFCH) and its associated first time resource (e.g., PSSCH), which allows for the possibility of using more than one PSFCH occasion for sending the PSFCH acknowledging the PSSCH.

Any aspect of the technique may be implemented as a method of transmitting or receiving a HARQ feedback for SL in unlicensed spectrum.

The technique may be implemented in accordance with a 3GPP specification, e.g., for 3GPP release 17 or a future release 18. Alternatively or in addition, the technique may be implemented for any radio access technology (RAT) supporting SL, e.g. according to 3GPP LTE or 3GPP NR.

Any wireless device (e.g., a radio device) may be a user equipment (UE), e.g., according to a 3GPP specification. The first wireless device may also be referred to as a receiving UE (or briefly: RX UE or receiver) or UE wherein the context allows for the role of the RX UE. Alternatively or in addition, the second wireless device may also be referred to as a transmitting UE (or briefly TX UE or transmitter) or UE wherein the context allows for the role of the TX UE. Alternatively or in addition, at least one wireless device may embody the functionality of both the first wireless device and the second wireless device.

Optionally, the first and/or second wireless devices and a radio access network (RAN) may be wirelessly connected in an uplink (UL) and/or a downlink (DL) through a Uu interface. Alternatively or in addition, the SL may enable a direct radio communication between proximal wireless devices, e.g., the first and second wireless devices, optionally using a PC5 interface. Optionally, the SL between the first and second wireless devices may include one or more intermediate wireless device (also referred to as hops). Services provided using the SL or the PC5 interface may be referred to as proximity services (ProSe). Any wireless device supporting a SL may be referred to as ProSe-enabled radio device.

The first wireless device and/or the second wireless device and/or the RAN may form, or may be part of, a radio network, e.g., according to the Third Generation Partnership Project (3GPP) or according to the standard family IEEE 802.11 (Wi-Fi). The first method aspect and the second method aspect may be performed by one or more embodiments of the first wireless device and the second wireless device, respectively.

The RAN may comprise one or more base stations (e.g., network nodes), e.g., controlling or (e.g., pre-) configuring the first and/or second method aspect. Alternatively or in addition, the radio network may be a vehicular, ad hoc and/or mesh network comprising two or more wireless device devices, e.g., acting as the first wireless device and/or the second wireless device.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations (e.g., network nodes).

The base station or network node may encompass any station that is configured to provide wireless (e.g., radio) access to any of the wireless devices. The base stations may also be referred to as cell, transmission and reception point (TRP), radio access node or access point (AP). The base station and/or a relay radio device may provide a data link to a host computer providing the user data to the remote radio device or gathering user data from the remote radio device. Examples for the network node (e.g., base station) may include a 3G base station or Node B (NB), 4G base station or eNodeB (eNB), a 5G base station or gNodeB (gNB), a Wi-Fi AP, and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

Any one of the devices, the UE, a base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for transmitting a feedback message on a SL;

FIG. 2 shows a schematic block diagram of an embodiment of a device for receiving a feedback message on a SL;

FIG. 3 shows a flowchart for a method of transmitting a feedback message on a SL, which method may be implementable by the device of FIG. 1;

FIG. 4 shows a flowchart for a method of receiving a feedback message on a SL, which method may be implementable by the device of FIG. 2;

FIG. 5 schematically illustrates an example of a radio network comprising embodiments of the devices of FIGS. 1 and 2 for performing the methods of FIGS. 3 and 4, respectively;

FIG. 6 schematically illustrates a first example of a time domain of a SL, which may result from embodiments of the devices of FIGS. 1 and 2 performing the methods of FIGS. 3 and 4, respectively, in SL communication;

FIG. 7 schematically illustrates a second example of a time domain of a SL, which may be applied to embodiments of the devices of FIGS. 1 and 2 performing the methods of FIGS. 3 and 4, respectively, in SL communication;

FIG. 8A schematically illustrates a time domain of a SL, which may result from a first group embodiments of the devices of FIGS. 1 and 2 performing the methods of FIGS. 3 and 4, respectively, in SL communication;

FIG. 8B schematically illustrates a time domain of a SL, which may result from a second group embodiments of the devices of FIGS. 1 and 2 performing the methods of FIGS. 3 and 4, respectively, in SL communication;

FIG. 9 schematically illustrates a first example of a time domain of a SL, which may result implementing the first group embodiments;

FIG. 10 schematically illustrates a second example of a time domain of a SL, which may result implementing the first or the second group embodiments;

FIG. 11 schematically illustrates a third example of a time domain of a SL, which may result implementing the second group embodiments;

FIG. 12 schematically illustrates a further example of a time domain of a SL, which may be implemented in any embodiment;

FIG. 13 shows a schematic block diagram of a wireless device embodying the device of FIG. 1;

FIG. 14 shows a schematic block diagram of a wireless device embodying the device of FIG. 2;

FIG. 15 schematically illustrates an example telecommunication network connected via an intermediate network to a host computer;

FIG. 16 shows a generalized block diagram of a host computer communicating via a base station or radio device functioning as a gateway with a user equipment over a partially wireless connection; and

FIGS. 17 and 18 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

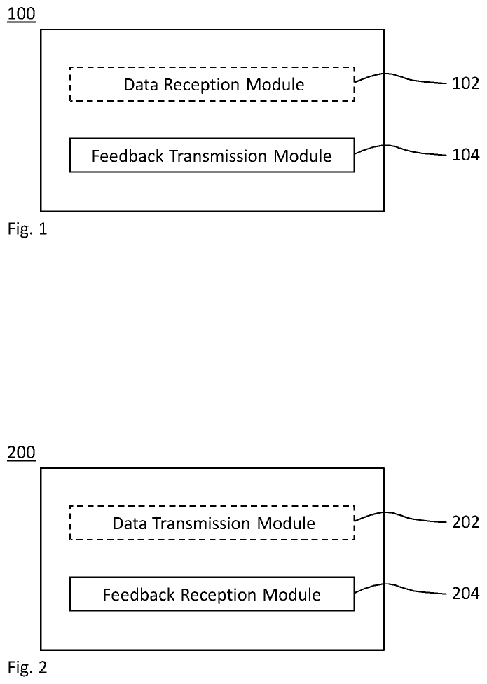

FIG. 1 schematically illustrates a block diagram of an embodiment of a device for transmitting a feedback message on a sidelink (SL). The device is generically referred to by reference sign 100.

The device 100 comprises optionally a data reception module 102 that receives or attempts to receive the data in a first time resource of a data channel from a second wireless device at a first wireless device on the SL.

The device 100 comprises a feedback transmission module 104 that transmits, responsive to a first time resource for data reception, a feedback message using a second time resource out of at least two time resource candidates of a feedback channel from the first wireless device to the second wireless device on the SL. The at least two time resource candidates are associated to the first time resource according to a temporal relation between the first time resource and each of the time resource candidates.

Any of the modules of the device 100 may be implemented by units configured to provide the corresponding functionality.

The device 100 may also be referred to as, or may be embodied by, the first wireless device (or briefly: data receiver or RX UE). The first wireless device 100 and the second wireless device may be in direct radio communication, e.g., at least for the data reception and/or feedback transmission. The second wireless device may be embodied by the device 200 below.

FIG. 2 schematically illustrates a block diagram of an embodiment of a device for receiving a feedback message on a sidelink (SL). The device is generically referred to by reference sign 200.

The device 200 comprises optionally a data transmission module 202 that transmits the data using a first time resource of a data channel on the SL from a second wireless device to a first wireless device.

The device 100 comprises a feedback reception module 204 that receives, responsive to a data transmission using a first time resource, a feedback message in a second time resource out of at least two time resource candidates of a feedback channel from the first wireless device at the second wireless device on the SL. The at least two time resource candidates are associated to the first time resource according to a temporal relation between the first time resource and each of the time resource candidates.

Any of the modules of the device 200 may be implemented by units configured to provide the corresponding functionality.

The device 200 may also be referred to as, or may be embodied by, the second wireless device (or briefly: data transmitter or TX UE). The second wireless device 200 and the first wireless device may be in direct radio communication, e.g., at least for the data transmission and/or feedback reception. The first wireless device may be embodied by the device 100 above.

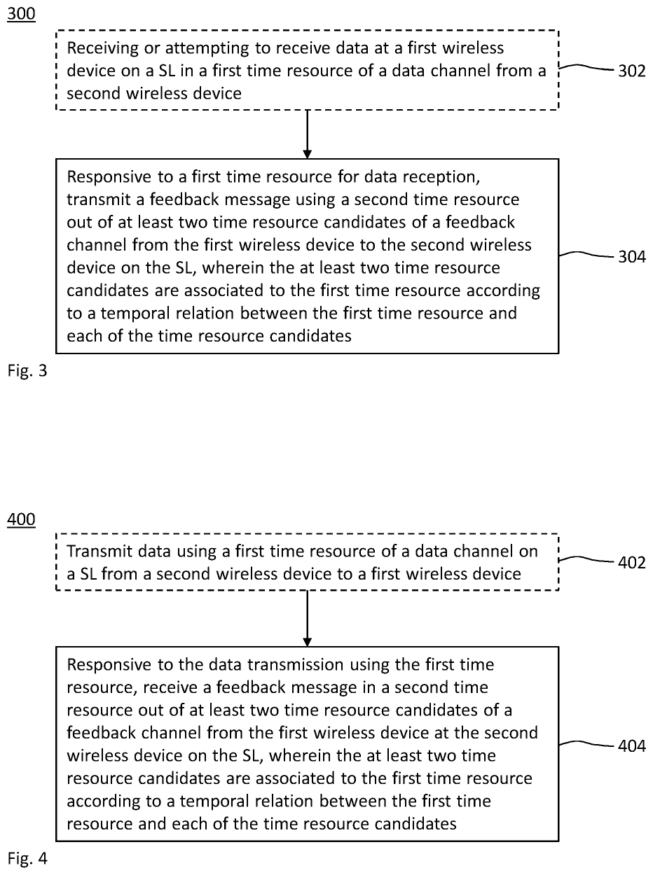

FIG. 3 shows an example flowchart for a method 300 according to the first method aspect and/or the embodiment 1 in the list of embodiments.

The method 300 comprises the optional step 302 and the step 304 indicated in FIG. 3.

The method 300 may be performed by the device 100. For example, the modules 102 and 104 may perform the steps 302 and 304, respectively.

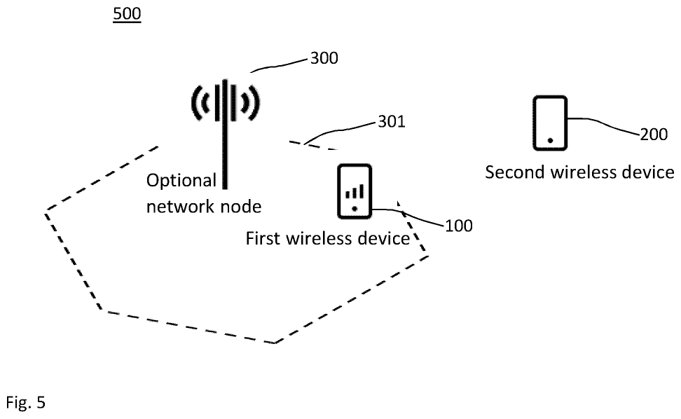

FIG. 4 shows an example flowchart for a method 400 according to the second method aspect and/or the embodiment 27 in the list of embodiments.

The method 400 comprises the optional step 402 and the step 404 indicated in FIG. 4.

The method 400 may be performed by the device 200. For example, the modules 202 and 204 may perform the steps 402 and 404, respectively.

FIG. 5 schematically illustrates an example of a radio network 500 comprising embodiments of the devices 100 and 200 for performing the methods 300 and 400, respectively. Optionally, at least one of the devices 100 and 200 is in coverage of a (e.g. terrestrial) radio access network comprising network nodes 510 providing radio access in cells 511.

In any aspect, the technique may be applied to uplink (UL), downlink (DL) or direct communications between radio devices, e.g., device-to-device (D2D) communications or sidelink (SL) communications.

Each of the first wireless device 100 and second wireless device 200 may use light (e.g., infra-red light) for the SL communication or may be a radio device. Herein, any radio device may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Any aspect and embodiment may implement the SL using SL resource pool, e.g., according to a resource pool configuration.

Radio resources for SL communication are organized into SL resource pool. An NR SL resource pool consists of radio resources spanning both time and frequency domain. In time domain, the SL resource pool consists of NR slots indexed in an ascending order, starting from index 0 up to a maximum index value. Once this maximum index is reached, the slot indexing is started again from index 0, and so on.

Any aspect and embodiment may implement the feedback message or the feedback channel according to Hybrid Automatic Repeat reQuest (HARQ) feedback, e.g., in NR SL.

For NR SL unicast and groupcast, the Hybrid Automatic Repeat reQuest (HARQ) can be used to improve the reliability of communication. Specifically, the receiver UE (Rx UE) of a data packet sends back to the transmitter UE (Tx UE) a positive acknowledgement (ACK) if the Rx UE has decoded the packet correctly. Otherwise, the Rx UE sends a negative acknowledgement (NACK), which acts as a request for the Tx UE to resend the packet. As a result, the Tx UE will transmit a new packet in case of receiving an ACK and retransmit either the same version or a different version of the initial packet in case of receiving a NACK. Sometimes only ACKs or only NACKs are allowed in the system, but that is not in focus of the present disclosure.

NR SL specifies a new physical channel, termed Physical Sidelink Feedback Channel (PSFCH), to convey the HARQ feedback (i.e., the ACK and/or the NACK) from the Rx UE to the Tx UE. Some features of the PSFCH design in NR SL are described below:
A SL resource pool has dedicated slots in which the PSFCH can be transmitted, often referred to as PSFCH occasions or PSFCH slots. A PSFCH consists of two identical OFDM symbols transmitted near the end of a PSFCH slot (i.e., the preceding OFDM symbols in the same slot can be used for data transmission). The PSFCH occasion can be (pre-)configured to be located at every N-th slot of the SL resource pool, where N=1, 2, or 4. In some cases, no PSFCH is allowed in a resource pool, but that is not in the scope of the present disclosure.
For a Physical Sidelink Shared Channel (PSSCH) transmission (i.e., a transmission of data packet) in slot n, the corresponding HARQ feedback is transmitted in the first PSFCH occasion occurring at or after slot n+M, where M=2 or 3 to take into account processing delay at the UEs.
Each PSFCH transmission uses one physical resource block (PRB) and uses a certain code (namely, a certain cyclic shift to be applied on a base sequence). PSFCH for different PSSCH are multiplexed in a PSFCH slot in both the PRB domain and the code domain. There is a rule for mapping between the slot and the subchannels in which a PSSCH is transmitted (besides some identifications of the Tx UE and the Rx UE) and the resource (namely the PRB and the code) to be used by the corresponding PSFCH. Based on this mapping, the Tx UE and the Rx UE know which resource to send and to receive a PSFCH.
Each PSFCH carries only 1 bit HARQ FB. Sometimes a UE needs to send more than one PSFCH in the same PSFCH slot, and therefore the UE may need to drop some of the PSFCH. The rule for prioritizing which PSFCH to transmit is typically based on a priority value associated with the corresponding PSSCH.

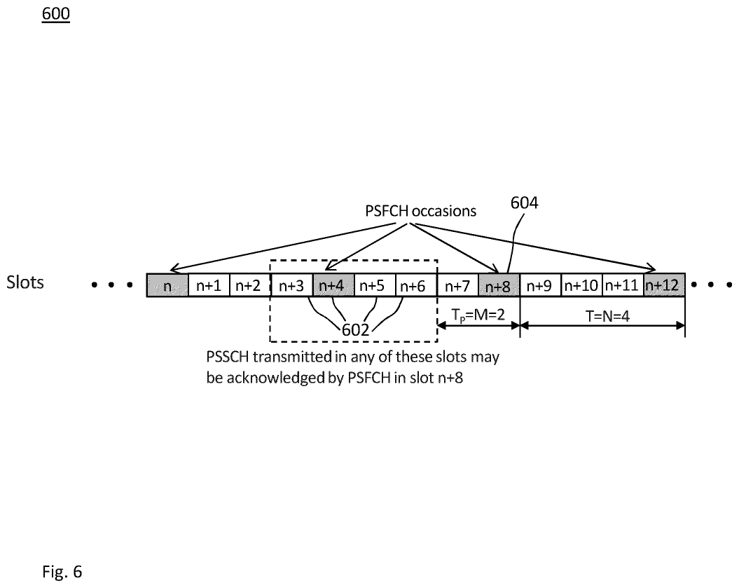

FIG. 6 illustrates a segment 600 of a SL resource pool containing PSFCH occasions for the case N=4 and M=2 in the time domain (time increasing from left to right).

Examples of the first time resource are indicated at reference sign 602. Each of the first time resource 602 is associated to a second time resource 604. For illustration and without limitation, any time resources are slots in below embodiments.

FIG. 6 illustrates an example of a segment 600 of a sidelink resource pool with T=N=4 and Tₚ=M=2. Due to the constraint (e.g., a processing delay) set by M or Tₚ, only the PSSCH transmitted in slots [n+3, n+6] can be acknowledged by PSFCH transmitted in the PSFCH occasion in slot n+8.

Any aspect and embodiment may operate in unlicensed spectrum, e.g., according to NR operation in unlicensed spectrum.

The 5G NR supports performing uplink and downlink transmissions in unlicensed spectrum since Rel-16. The unlicensed spectrum can be used by any device as long as certain rules for using the channel is met. These rules are often set by regulatory bodies in different parts of the world. In the following, we describe some technical components for operation in unlicensed spectrum.

Any aspect and embodiment may implement a channel access and/or channel occupancy time (COT) sharing.

In unlicensed spectrum the transmission medium (i.e., the channel) is shared by multiple equipments (e.g., any combination of wireless devices 100 and 200, network nodes 510, etc.), which may correspond to multiple users. To avoid conflicts and collisions of transmissions, channel access procedures are defined, which may also be referred to as procedures for shared spectrum access. The channel access procedure typically involves the following steps:
Sensing the channel for a certain period to detect whether other equipment are transmitting. This is sometimes referred to as performing clear channel assessment (CCA).
If the channel is sensed as busy (i.e., CCA was unsuccessful or failed), the transmitter does not transmit.
If the channel is sensed as idle (i.e., CCA was successful), the transmitter makes use of the channel (e.g., transmits the information or signals, etc.), optionally subject to a random backoff time.

The channel is utilized for a certain time, which is referred to as the channel occupancy time (COT). In some cases, different equipments may share a COT, e.g., for the data reception in the step 302 and the feedback message in the step 304.

By way of example:
An equipment B (e.g. the wireless device 200) performs CCA and gains access to the channel (i.e., CCA is successful), and performs some transmission, e.g., according to the step 402.
   As part of the transmission 402, the equipment B (e.g. the wireless device 200) informs an equipment A (e.g. the wireless device 100) that the COT is shared by equipment B (e.g. the wireless device 200).
The COT shared by equipment B (e.g. the wireless device 200) gives equipment A (e.g. the wireless device 100) access to the channel. Equipment A (e.g. the wireless device 100) performs some transmission, e.g., according to the step 304. This may end the COT or the COT may be shared back to the equipment B (e.g. the wireless device 200).

Alternatively or in addition, e.g., for very short transmissions that are sparse in time, a transmitter 100 or 200 may be allowed to transmit 402 or 304 without performing CCA.

These procedures allow for different NR nodes (e.g., UEs, base stations, etc. as examples of the above equipment) to share the channel among them but also with devices using other technologies (e.g., Wi-Fi).

In any aspect and embodiment, the SL may be implemented in unlicensed spectrum (SL-U).

In Release 18, 3GPP will specify mechanisms that enable the operation of SL communications in unlicensed spectrum, sometimes referred to as SL-U. It is expected that SL-U design will take NR SL and NR-U designs as baseline.

Any of the parameters, e.g. for the temporal relation, may controlled by means of configuration and pre-configuration.

In cellular systems, the network typically configures some parameters used by the UEs. This configuration is typically signaled by a NW node (e.g., a gNB) to the UE (e.g., using RRC signaling, broadcast signaling such as MIB or SIB, or some other type of signaling). This is applicable to UEs performing sidelink transmissions if they are in coverage of a network.

UEs that are out of network coverage but participate in sidelink communications, may be provided the corresponding parameters by means of a pre-configuration (e.g., stored in the subscriber identity module, SIM).

Unless explicitly stated, we will use the terms configuration, pre-configuration, or (pre-) configuration to denote both ways of providing the corresponding configuration/parameters to a UE.

The current disclosure involves sidelink (SL) communications in unlicensed spectrum. Under this assumption, it is important to note that the radio resources are shared between SL users (here after denoted as SL-U users or SL users) and between SL users and non-SL users such as Wi-Fi devices.

Unless specified otherwise, the following terminology is applied.
PSFCH occasion or PSFCH slot denotes a slot in which there are resources for PSFCH transmission as defined in the resource pool
PSSCH slot denotes a slot in which a PSSCH is/can be transmitted.
A PSFCH carrying HARQ FB for a PSSCH is called the associated PSFCH of the PSSCH. Vice versa, the PSSCH is called the associated PSSCH of the PSFCH.
PSFCH and HARQ FB may be used interchangeably.

The SL may comprise at least a (e.g., physical) data channel and a (e.g., physical) feedback channel. The data channel may be a physical SL shared channel (e.g., PSCCH)a In the current NR SL design, a SL resource pool can be configured with dedicated radio resources for feedback transmissions on a physical sidelink control channel (PSFCH), which occur at every N-th slot (also known as PSFCH occasions).

In any aspect or embodiment, together with a constraints set by processing delay (e.g., the parameters M or Tₚ herein), the temporal relation (or timing relation) between a PSSCH and its associated PSFCH may be deterministic.

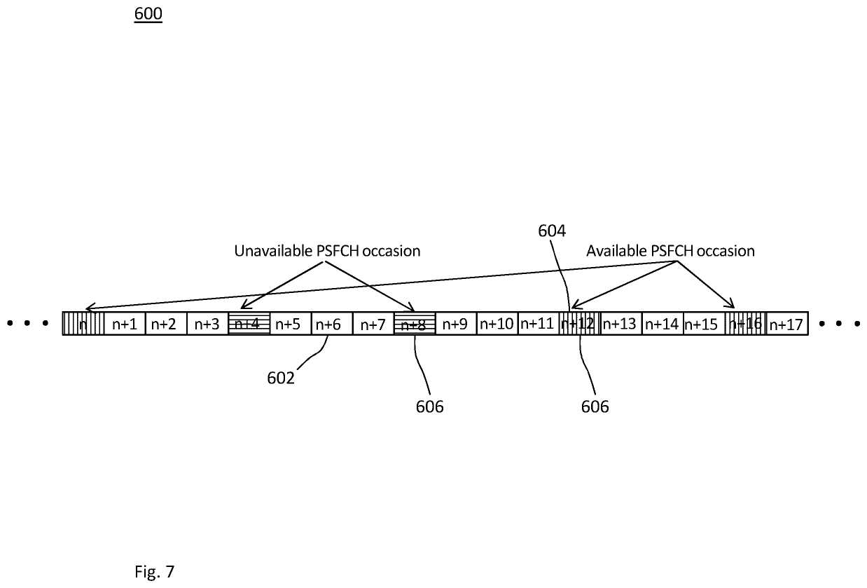

One of the main design targets of SL-U is to reuse as much as possible the existing design of NR SL. It is therefore tempting to assign dedicated resources for HARQ feedback transmissions (i.e., for PSFCH transmissions) as done in NR SL Rel-16. In so doing, all SL-U UEs will have the same understanding of where to transmit and receive PSFCH and the existing procedures for PSFCH transmissions in NR SL can be reused. However, such resources are dedicated for PSFCH only from the SL-U perspective, i.e., there is no guarantee that the resources are not occupied by non-SL-U devices (such as Wi-Fi devices) because the spectrum is unlicensed. As an example, FIG. 7 illustrates a scenario where PSFCH occasions are configured at every N=4 slots but some of the occasions (e.g., at slot n+4 and n+8) cannot be used for PSFCH transmissions since the channel is busy due to non-SL-U transmissions (e.g., Wi-Fi transmissions). This problem of unavailable or lost PSFCH occasions calls for changes to NR SL HARQ FB procedure for it to work in the SL-U context.

FIG. 7 schematically illustrates an example of dedicated PSFCH occasions under unlicensed spectrum operation. Striped boxes denote PSFCH occasions. In this example, N=4 and the PSFCH occasions at slot n+4 and slot n+8 cannot be used due to busy channel (e.g., channel occupied by non-SL-U transmissions). In other words, only the second time resource 604 out of the time resource candidates 606 is available.

Embodiments of the technique can alleviate the problem caused by unusable PSFCH occasions by relaxing the time relationship between a PSSCH and its associated PSFCH of Release 16. Specifically, instead of fixing a single PSFCH occasion, in which a PSFCH can be transmitted, embodiments allow a PSFCH to be transmitted in more than one PSFCH occasion, as long as the time interval between the PSSCH transmission to be acknowledged and the associated PSFCH does not exceed a threshold. These PSFCH occasions are termed candidate PSFCH occasions associated with the PSSCH. UE behaviors are adapted accordingly.

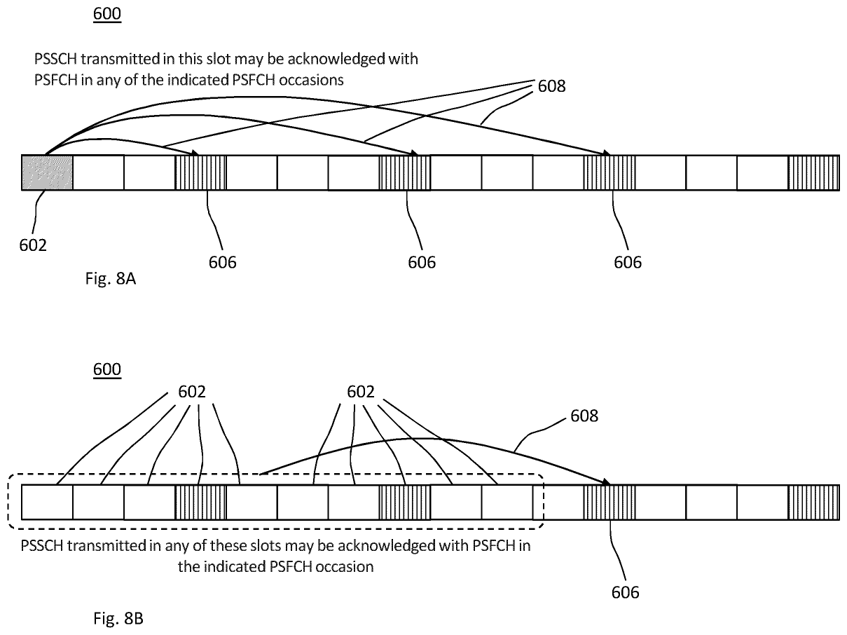

Any aspect or embodiment may comprise or use at least one of:
PSFCH occasions configuration: PSFCH resources for SL-U are (pre-)configured in the same way as in NR SL, i.e., every N^{th} slot in a SL resource pool has dedicated radio resources for transmitting PSFCH.
Determining candidate PSFCH occasions for a HARQ FB: For each PSSCH, the corresponding candidate PSFCH occasions are determined based on a first group of embodiments of the methods 300 and 400. Alternatively, each PSFCH occasion is a candidate PSFCH occasion for acknowledging a PSSCH transmitted in any of a number of different slots, which are determined based on a second group of embodiments of the methods 300 and 400, e.g. presented in below Section. A conceptual illustration of these two alternatives are given in FIGS. 8A and 8B and/or referred to as Method 1 and 2 and/or first and second group of embodiments, respectively.

FIG. 8A and FIG. 8B show conceptual illustration of two alternatives for determining candidate PSFCH occasions. Striped boxes denote PSFCH occasions.

UE behaviors for transmitting and/or receiving PSFCH in the step 304 and 404 using the PSFCH occasions are described in a section further below (indicated by “following UE behaviors”).

Embodiments may include at least one of the following methods for determining candidate PSFCH occasions.

In the following we describe two methods for determining the timing relationship between a PSSCH and its associated candidate PSFCH occasions. These two methods are equivalent in many (but not all) scenarios, including the most interesting ones. This is explained in more detail further below.

A Method 1 or a first group of embodiments: For a PSSCH transmitted at slot T1, the associated PSFCH can be transmitted in the next K PSFCH occasions located at or after slot T1+Tₚ, where K is an integer larger than 1 and Tₚ denotes a number of slots accounting for processing delay at the UE. These K PSFCH occasions are the candidate PSFCH occasions associated with the PSSCH. Equivalently, the set of candidate PSFCH occasions for a PSSCH is all PSFCH occasions lying within K·N+Tₚ−1 slots immediately following the PSSCH slot T1.

Numerically, the K candidate PSFCH occasions associated with a PSSCH transmitted in slot T1 are located at slot T1+Tₚ+T_{d}+k*N, where k=0, 1, . . . , K−1 and T_{d} is the number of slots between slot T1+Tₚ and the immediate PSFCH occasion located at or after slot T1+Tₚ (i.e., T_{d}=0 if slot T1+Tₚ is a PSFCH occasion itself, T_{d}=2 if slot T1+Tₚ is not a PSFCH occasion and the next PSFCH occasion is at slot T1+Tₚ+2).

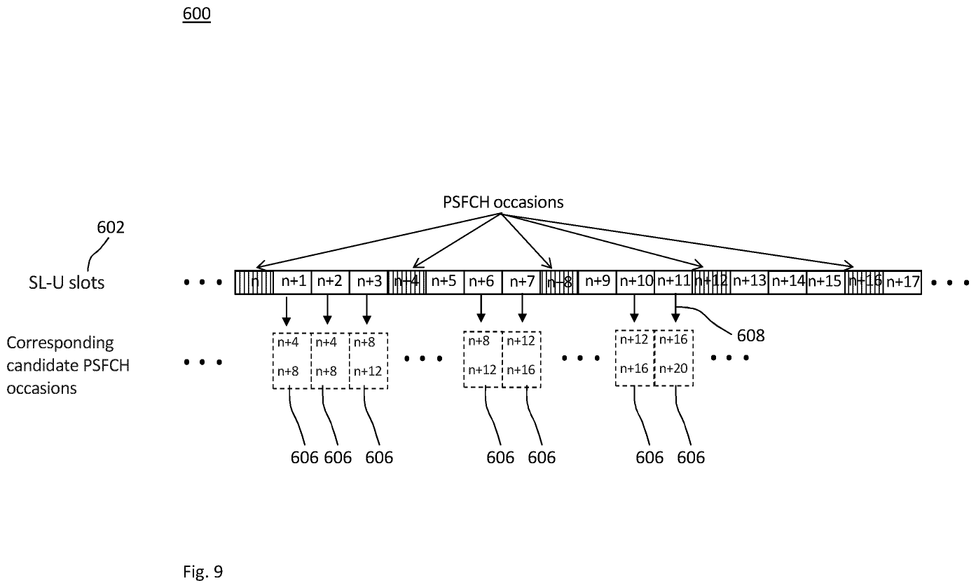

An example of Method 1 is given in FIG. 9, wherein K=2 (i.e., each PSSCH has up to two chances to be acknowledged), N=4, and Tₚ=2. As such, the PSFCH acknowledging a PSSCH transmitted in slot n+1 and n+2 can be transmitted in two PSFCH occasions, at slot n+4 and slot n+8, respectively. Meanwhile, due to TP, PSFCH for a PSSCH transmitted in slot n+3 can be transmitted in two PSFCH occasions, at slot n+8 and n+12, respectively. The procedure is continued in the same manner for PSSCH transmitted in other slots.

FIG. 9. Example of method 1 (i.e., the first group of embodiments) for determining candidate PSFCH occasions, where K=2, N=4, Tₚ=2. For a PSSCH transmitted in slot n+1, T_{d}=1 and the candidate PSFCH occasions are at slot n+4 and n+8. For a PSSCH transmitted in slot n+3, T_{d}=3 and the candidate PSFCH occasions are at slot n+8 and n+12. As a result, the PSFCH occasion in slot n+12 is a candidate PSFCH occasion for PSSCH in slot n+3 to slot n+10.

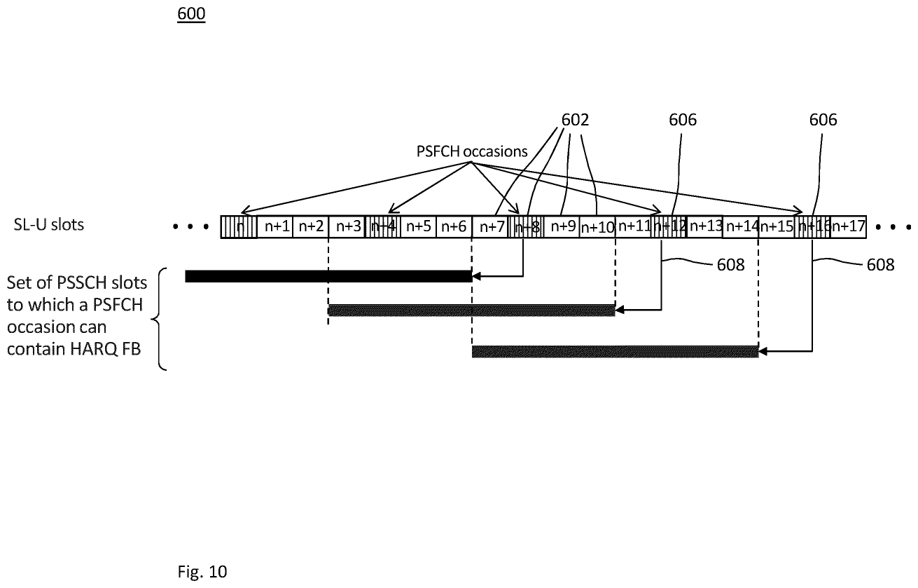

Method 2 or second group of embodiments: A PSFCH occasion at slot T2 contains resources for PSFCH associated with PSSCH transmitted in any of T previous slots, subject to processing delay Tₚ, where T>N and Tₚ denotes the number of slots accounting for processing delay at the UE. In other words, a PSFCH occasion at slot T2 is a candidate PSFCH occasion that may be used for acknowledging the PSSCH transmitted in slots T2−Tₚ−T+1 to slot T2−Tₚ (inclusive). An example is given in FIG. 10 where N=4, Tₚ=2, and T=8.

FIG. 10 schematically illustrates an example of Method 2 (i.e., the second group of embodiments) for determining candidate PSFCH occasions, where T=8, N=4, Tₚ=2. Each black bar denotes a set of PSSCH slots which can be acknowledged by PSFCH transmitted in a PSFCH occasion. A PSFCH occasion in slot T2 is a candidate PSFCH occasion for PSSCH transmitted in slots [T2−Tₚ−T+1, T2−Tₚ]. Therefore, the PSFCH occasion in slot n+12 is a candidate PSFCH occasion for PSSCH in slot n+3 through slot n+10, and the PSFCH occasion in slot n+16 is a candidate PSFCH occasion for PSSCH transmitted in slot n+7 through slot n+14.

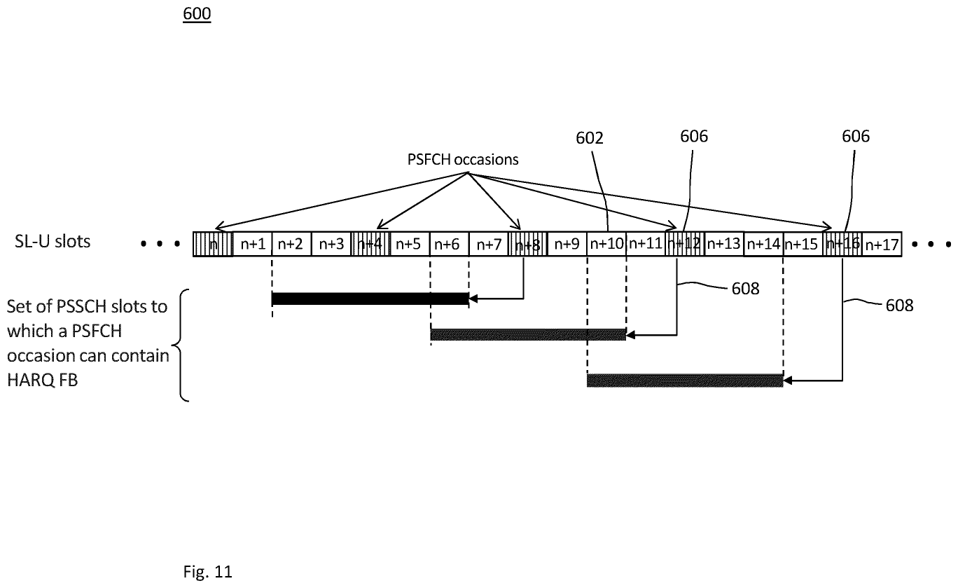

The two methods described above may be implemented considering the following effects and advantages.
Method 1 is more natural from the viewpoint of the UE transmitting PSSCH (i.e., receiving PSFCH), while method 2 is more natural from the viewpoint of the UE transmitting PSFCH.
Method 1 is slightly more complex to describe in mathematical formulae than method 2 since method 1 requires one more parameter (T_{d}).
Method 1 and method 2 are identical when T=K·N. This can be seen by comparing the examples in FIG. 9 and FIG. 10. In fact, the set of PSSCH slots which can be associated with a given PSFCH occasion in the two examples are identical because T=8=2·4=K·N. In case T>N but T is not equal to K·N, method 2 is not the same as method 1, as illustrated in FIG. 11.

FIG. 11 schematically illustrates an example of Method 2 (i.e., the second group of embodiments) with N=4, Tₚ=2, T=5. Unlike in the previous example in FIG. 10, in this example, due to T not equal to a multiple of N, some slots (e.g., slot n+6 and n+10) have more than one candidate PSFCH occasions while other slots (e.g., slot n+7 and n+11) have a single candidate PSFCH occasion.

### Embodiments Related to the Parameters in the Methods

In one embodiment, the one or more of the parameters N, K, T can be determined based on at least one of the following factors:
The interference condition to SL-U. E.g., in an environment where many non-SL-U devices (e.g., Wi-Fi devices) are expected, for a fixed N, the value of K (or T) can be increased since the chance that a PSFCH occasion is lost due to failed channel access is high. In contrast, in an environment where few or no non-SL-U devices are expected or the number of those devices can be controlled (e.g., in a factory), the value of K (or T) can be set small.
   In one example, the interference condition is indicated by a control signaling such as an RRC parameter.
The typical latency or the most stringent latency requirement of the use cases targeted by the SL-U devices. For example, N and/or K or T can be set small for use cases with low-latency requirement.
The numerology to be used. E.g., given a latency target, under large subcarrier spacing (i.e., short slot duration), the value of N and/or K or T can be larger than under short subcarrier spacing (i.e., long slot duration). On the other hand, given a reliability target, under large subcarrier spacing, the value of N and/or K or T can be smaller than under short subcarrier spacing.
Upper bounded by the number of PRBs available for PSFCH transmissions so that there is one-to-one mapping of subchannels per slot and PRBs available for PSFCH transmissions.

In one embodiment, the value of K or T is (pre) configured per priority level associated with PSSCH, where the priority value of a PSSCH can be indicated by the sidelink control information (SCI) scheduling the PSSCH.

In one embodiment, the value of K or T can be (pre) configured per resource pool. In such cases, the number of PSFCH occasions which can be used for acknowledging a PSSCH can be determined based on an indicator associated with the PSSCH (e.g., a priority value indicated by the SCI scheduling the PSSCH) provided that the number is less than or equal to K. For example, K=4 is configured for a resource pool. However, for a packet with low latency requirement, only the HARQ FB received in the first and/or the second candidate PSFCH occasions are useful in meeting the latency requirement. For such a packet, the Tx UE (i.e., the UE transmitting the PSSCH) can signal the number of meaningful PSFCH occasions (equals 2 in the current example) to the Rx UE (i.e., the UE receiving the PSSCH and hence transmitting the PSFCH) using a field in the SCI scheduling the PSSCH.

In one related embodiment, the number of PSFCH occasions which can be used for acknowledging a PSSCH is related to the PSSCH contents (e.g., the index or configuration of some of the logical channels multiplexed, etc.). In this case, the number of PSFCH occasions which can be used for acknowledging a PSSCH is related to the PSSCH contents may not be explicitly or implicitly indicated in the transmission. On the contrary, the receiver may not be aware, except for the maximum configured per resource pool (e.g., K=4). However, the transmitter UE may retransmit the message earlier than this maximum value.

### Embodiments Related to PSFCH Resource Determination

Background: Typically, each PSFCH occasion is (pre) configured with a set of PRBs that can be used for PSFCH transmissions (e.g., it is not necessary that all PRBs in that occasion are to be used for PSFCH transmissions). Besides the frequency domain resources (e.g., the PRBs), the code domain (e.g., cyclic shifts to be applied to certain base sequences) can be used to multiplex PSFCH. Below we include some embodiments related to how to organize these PSFCH resources in a PSFCH occasion.

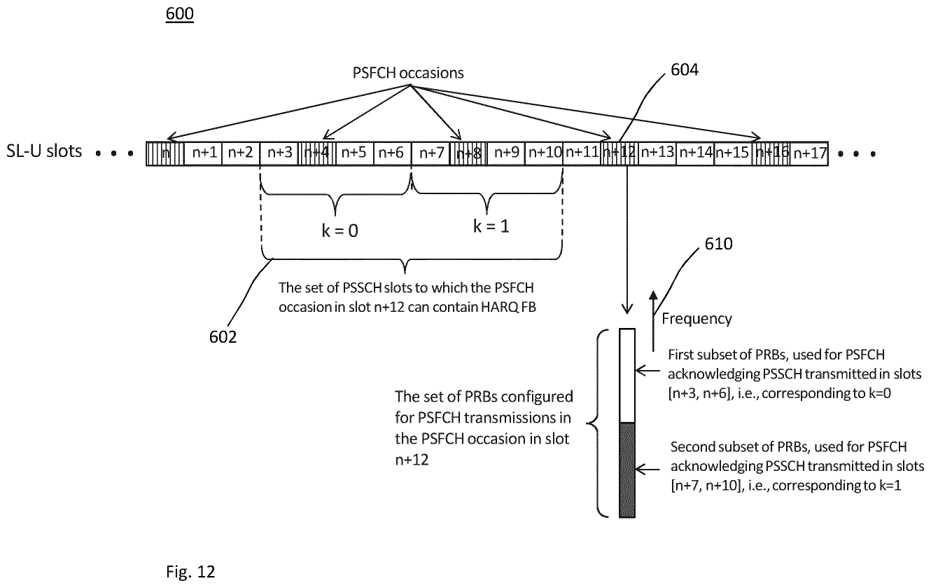

In one embodiment, within the set of configured PRBs for PSFCH in a PSFCH occasion, non-overlapping subsets of PRBs are used for transmitting PSFCH acknowledging PSSCH transmitted in different sets of slots corresponding to different values of k∈{0, 1, . . . , K−1}. FIG. 12 illustrates a concept of this embodiment, for illustration and not limitation as a continuation of the example given in FIG. 10.

FIG. 12 schematically illustrates an example of using non-overlapping subsets of PRBs in the frequency domain 610 in a PSFCH occasion 604 for transmitting 304 PSFCH acknowledging PSSCH transmitted 402 in slots 602 corresponding to different values of k∈{0, 1, . . . , K−1}. This example is based on the example given in FIG. 10, with N=4, K=2, Tₚ=2. Note that the increasing order of indexing k can be from left to right (i.e., forward in time) or from right to left (i.e., backward in time).

In one embodiment, within the set of configured PRBs for PSFCH in a PSFCH occasion, different codes (e.g., different values of cyclic shifts and/or cyclic shift pairs) are used for PSFCH acknowledging PSSCH transmitted in different sets of slots corresponding to different values of k∈{0, 1, . . . , K−1}.

Any embodiment may implement at least one of the following UE behaviors.

The following embodiments can be used individually or combined in a meaningful manner.

At least one of the following features and steps may be implemented by a UE transmitting PSFCH, e.g., first wireless device, the data receiving UE or the UE 100.

In an embodiment, a UE transmits, in a PSFCH occasion, a HARQ FB (i.e., a PSFCH) targeting a PSSCH if the PSFCH occasion is a candidate PSFCH associated with the PSSCH and the corresponding HARQ FB has not been sent in a previous candidate PSFCH occasion. For example, the PSFCH was not sent in a previous candidate PSFCH occasion due to a failed channel access. In another example, the PSFCH was not sent in a previous candidate PSFCH occasion due to certain prioritization rules (e.g., the UE prioritized transmitting another PSFCH in that same PSFCH occasion).

In another embodiment, a UE transmits PSFCH targeting a PSSCH using more than one candidate PSFCH occasions associated with the PSSCH (e.g., using all candidate PSFCH occasions that are available; or up to a (pre-)configured number of occasions). This way, the PSFCH reliability can be improved.

In another embodiment, a UE transmits PSFCH targeting a PSSCH using more than one candidate PSFCH occasions based on a priority value associated with the PSSCH. For example, a PSSCH with high priority has the possibility of receiving more than one PSFCH.

In an embodiment, a UE prioritizes transmitting HARQ FB targeting a PSSCH based on the number of remaining candidate PSFCH occasions associated with that PSSCH. E.g., an acknowledgement for a PSSCH with less remaining candidate PSFCH occasions is to be transmitted before an acknowledgement for a PSSCH with more remaining candidate PSFCH occasions.

At least one of the following features and steps may be implemented by a UE receiving PSFCH, e.g., the second wireless device, the data transmitting UE or the UE 200.

In an embodiment, a UE tries to detect PSFCH targeting a PSSCH in a candidate PSFCH occasion associated with the PSSCH if no PSFCH for that PSSCH has been detected in a previous candidate PSFCH occasion.

In another embodiment, a UE tries to detect PSFCH targeting a PSSCH in more than one candidate PSFCH occasions associated with the PSSCH, e.g., in all the candidate PSFCH occasions. In one example, the number of PSFCH occasions to be used is dependent on a priority value associated with the PSSCH.

In another embodiment, the UE combines the PSFCH received in multiple PSFCH occasions.

In one embodiment, the UE retransmits a packet based on a remaining PDB, without waiting for the last occasion in which the PSFCH can be transmitted.

At least some embodiments of the technique can be based on, or by augmenting, the 3GPP document TS 38.213, version 17.0.0, and/or the 3GPP document TS 38.331, version 16.7.0. Alternatively or in addition, the technique may be implemented to meet an SL enhancement defined in a 3GPP work item (WI) for Release 18 and/or in the 3GPP document RP-213678.

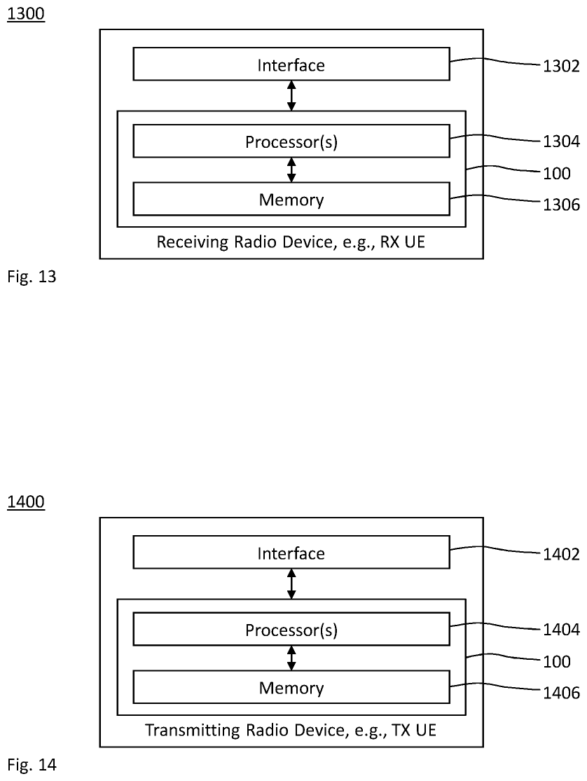

FIG. 13 shows a schematic block diagram for an embodiment of the device 100. The device 100 comprises processing circuitry, e.g., one or more processors 1304 for performing the method 300 and memory 1306 coupled to the processors 1304. For example, the memory 1306 may be encoded with instructions that implement at least one of the modules 102 and 104.

The one or more processors 1304 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1306, feedback transmitter functionality and/or data receiver functionality. For example, the one or more processors 1304 may execute instructions stored in the memory 1306. Such functionality may include providing various features and steps discussed herein, including any of the benefits disclosed herein. The expression “the device being operative to perform an action” may denote the device 100 being configured to perform the action.

As schematically illustrated in FIG. 13, the device 100 may be embodied by a (data) receiving wireless device 1300, e.g., functioning as an RX UE. The receiving wireless device 1300 comprises a radio interface 1302 coupled to the device 100 for radio communication with one or more peer wireless devices, e.g., functioning as a transmitting wireless device or a TX UE.

FIG. 14 shows a schematic block diagram for an embodiment of the device 200. The device 200 comprises processing circuitry, e.g., one or more processors 1404 for performing the method 400 and memory 1406 coupled to the processors 1404. For example, the memory 1406 may be encoded with instructions that implement at least one of the modules 202 and 204.

The one or more processors 1404 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1406, data transmitter functionality and/or feedback receiver functionality. For example, the one or more processors 1404 may execute instructions stored in the memory 1406. Such functionality may include providing various features and steps discussed herein, including any of the benefits disclosed herein. The expression “the device being operative to perform an action” may denote the device 200 being configured to perform the action.

As schematically illustrated in FIG. 14, the device 200 may be embodied by a transmitting wireless device 1400, e.g., functioning as a TX UE. The transmitting wireless device 1400 comprises a radio interface 1402 coupled to the device 200 for radio communication with one or more peer wireless devices, e.g., functioning as a receiving wireless device or a RX UE.

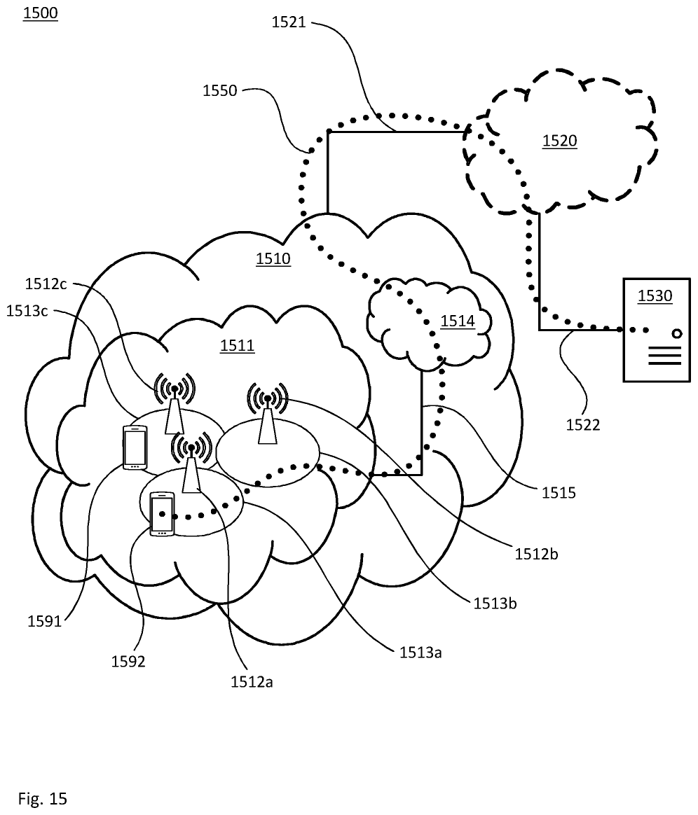

With reference to FIG. 15, in accordance with an embodiment, a communication system 1500 includes a telecommunication network 1510, such as a 3GPP-type cellular network, which comprises an access network 1511, such as a radio access network, and a core network 1514. The access network 1511 comprises a plurality of base stations 1512a, 1512b, 1512c, such as NBs, eNBs, gNBs or other types of wireless access points, each defining a corresponding coverage area 1513a, 1513b, 1513c. Each base station 1512a, 1512b, 1512c is connectable to the core network 1514 over a wired or wireless connection 1515. A first user equipment (UE) 1591 located in coverage area 1513c is configured to wirelessly connect to, or be paged by, the corresponding base station 1512c. A second UE 1592 in coverage area 1513a is wirelessly connectable to the corresponding base station 1512a. While a plurality of UEs 1591, 1592 are illustrated in this example, the disclosed embodiments are equally applicable to a situation where a sole UE is in the coverage area or where a sole UE is connecting to the corresponding base station 1512.

Any of the UEs 1591 and 1592 may embody the device 100 and/or the device 200.

The telecommunication network 1510 is itself connected to a host computer 1530, which may be embodied in the hardware and/or software of a standalone server, a cloud-implemented server, a distributed server or as processing resources in a server farm. The host computer 1530 may be under the ownership or control of a service provider, or may be operated by the service provider or on behalf of the service provider. The connections 1521, 1522 between the telecommunication network 1510 and the host computer 1530 may extend directly from the core network 1514 to the host computer 1530 or may go via an optional intermediate network 1520. The intermediate network 1520 may be one of, or a combination of more than one of, a public, private or hosted network; the intermediate network 1520, if any, may be a backbone network or the Internet; in particular, the intermediate network 1520 may comprise two or more sub-networks (not shown).

The communication system 1500 of FIG. 15 as a whole enables connectivity between one of the connected UEs 1591, 1592 and the host computer 1530. The connectivity may be described as an over-the-top (OTT) connection 1550. The host computer 1530 and the connected UEs 1591, 1592 are configured to communicate data and/or signaling via the OTT connection 1550, using the access network 1511, the core network 1514, any intermediate network 1520 and possible further infrastructure (not shown) as intermediaries. The OTT connection 1550 may be transparent in the sense that the participating communication devices through which the OTT connection 1550 passes are unaware of routing of uplink and downlink communications. For example, a base station 1512 need not be informed about the past routing of an incoming downlink communication with data originating from a host computer 1530 to be forwarded (e.g., handed over) to a connected UE 1591. Similarly, the base station 1512 need not be aware of the future routing of an outgoing uplink communication originating from the UE 1591 towards the host computer 1530.

By virtue of the method 300 and/or 400 being performed by any one of the UEs 1591 or 1592 as devices 100 and/or 200 (and/or controlled by any one of the base stations 1512), the performance or range of the OTT connection 1550 can be improved, e.g., in terms of increased throughput and/or reduced latency. More specifically, the host computer 1530 may indicate to the RAN 500 or the devices 100 and/or 200 (e.g., on an application layer) a QoS of the traffic or any other trigger for performing the method 300 and/or 400.

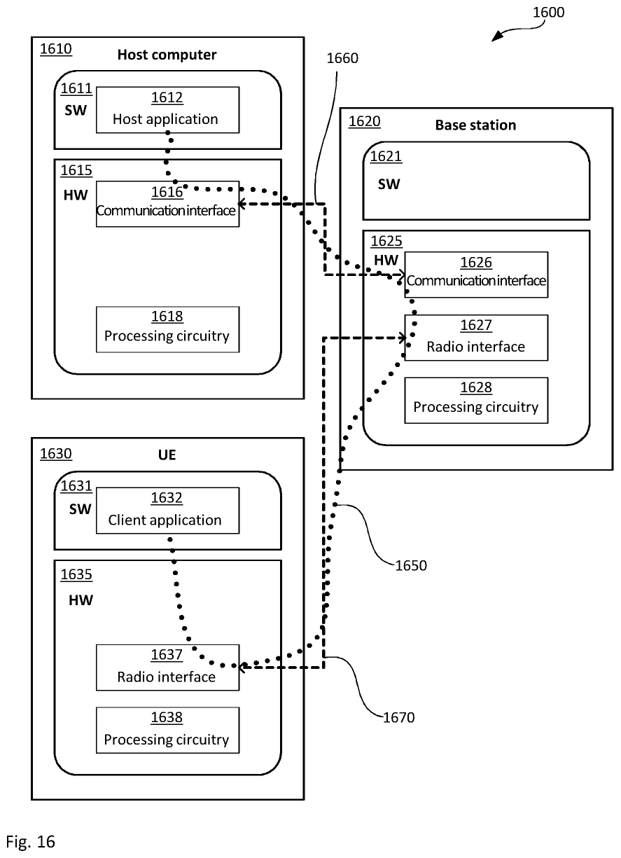

Example implementations, in accordance with an embodiment of the UE, base station and host computer discussed in the preceding paragraphs, will now be described with reference to FIG. 16. In a communication system 1600, a host computer 1610 comprises hardware 1615 including a communication interface 1616 configured to set up and maintain a wired or wireless connection with an interface of a different communication device of the communication system 1600. The host computer 1610 further comprises processing circuitry 1618, which may have storage and/or processing capabilities. In particular, the processing circuitry 1618 may comprise one or more programmable processors, application-specific integrated circuits, field programmable gate arrays or combinations of these (not shown) adapted to execute instructions. The host computer 1610 further comprises software 1611, which is stored in or accessible by the host computer 1610 and executable by the processing circuitry 1618. The software 1611 includes a host application 1612. The host application 1612 may be operable to provide a service to a remote user, such as a UE 1630 connecting via an OTT connection 1650 terminating at the UE 1630 and the host computer 1610. In providing the service to the remote user, the host application 1612 may provide user data, which is transmitted using the OTT connection 1650. The user data may depend on the location of the UE 1630. The user data may comprise auxiliary information or precision advertisements (also: ads) delivered to the UE 1630. The location may be reported by the UE 1630 to the host computer, e.g., using the OTT connection 1650, and/or by the base station 1620, e.g., using a connection 1660.

The communication system 1600 further includes a base station 1620 provided in a telecommunication system and comprising hardware 1625 enabling it to communicate with the host computer 1610 and with the UE 1630. The hardware 1625 may include a communication interface 1626 for setting up and maintaining a wired or wireless connection with an interface of a different communication device of the communication system 1600, as well as a radio interface 1627 for setting up and maintaining at least a wireless connection 1670 with a UE 1630 located in a coverage area (not shown in FIG. 16) served by the base station 1620. The communication interface 1626 may be configured to facilitate a connection 1660 to the host computer 1610. The connection 1660 may be direct, or it may pass through a core network (not shown in FIG. 16) of the telecommunication system and/or through one or more intermediate networks outside the telecommunication system. In the embodiment shown, the hardware 1625 of the base station 1620 further includes processing circuitry 1628, which may comprise one or more programmable processors, application-specific integrated circuits, field programmable gate arrays or combinations of these (not shown) adapted to execute instructions. The base station 1620 further has software 1621 stored internally or accessible via an external connection.

The communication system 1600 further includes the UE 1630 already referred to. Its hardware 1635 may include a radio interface 1637 configured to set up and maintain a wireless connection 1670 with a base station serving a coverage area in which the UE 1630 is currently located. The hardware 1635 of the UE 1630 further includes processing circuitry 1638, which may comprise one or more programmable processors, application-specific integrated circuits, field programmable gate arrays or combinations of these (not shown) adapted to execute instructions. The UE 1630 further comprises software 1631, which is stored in or accessible by the UE 1630 and executable by the processing circuitry 1638. The software 1631 includes a client application 1632. The client application 1632 may be operable to provide a service to a human or non-human user via the UE 1630, with the support of the host computer 1610. In the host computer 1610, an executing host application 1612 may communicate with the executing client application 1632 via the OTT connection 1650 terminating at the UE 1630 and the host computer 1610. In providing the service to the user, the client application 1632 may receive request data from the host application 1612 and provide user data in response to the request data. The OTT connection 1650 may transfer both the request data and the user data. The client application 1632 may interact with the user to generate the user data that it provides.

It is noted that the host computer 1610, base station 1620 and UE 1630 illustrated in FIG. 16 may be identical to the host computer 1530, one of the base stations 1512a, 1512b, 1512c and one of the UEs 1591, 1592 of FIG. 15, respectively. This is to say, the inner workings of these entities may be as shown in FIG. 16, and, independently, the surrounding network topology may be that of FIG. 15.

In FIG. 16, the OTT connection 1650 has been drawn abstractly to illustrate the communication between the host computer 1610 and the UE 1630 via the base station 1620, without explicit reference to any intermediary devices and the precise routing of messages via these devices. Network infrastructure may determine the routing, which it may be configured to hide from the UE 1630 or from the service provider operating the host computer 1610, or both. While the OTT connection 1650 is active, the network infrastructure may further take decisions by which it dynamically changes the routing (e.g., on the basis of load balancing consideration or reconfiguration of the network).

The wireless connection 1670 between the UE 1630 and the base station 1620 is in accordance with the teachings of the embodiments described throughout this disclosure. One or more of the various embodiments improve the performance of OTT services provided to the UE 1630 using the OTT connection 1650, in which the wireless connection 1670 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1650 between the host computer 1610 and UE 1630, in response to variations in the measurement results. The measurement procedure and/or the network functionality for reconfiguring the OTT connection 1650 may be implemented in the software 1611 of the host computer 1610 or in the software 1631 of the UE 1630, or both. In embodiments, sensors (not shown) may be deployed in or in association with communication devices through which the OTT connection 1650 passes; the sensors may participate in the measurement procedure by supplying values of the monitored quantities exemplified above, or supplying values of other physical quantities from which software 1611, 1631 may compute or estimate the monitored quantities. The reconfiguring of the OTT connection 1650 may include message format, retransmission settings, preferred routing etc.; the reconfiguring need not affect the base station 1620, and it may be unknown or imperceptible to the base station 1620. Such procedures and functionalities may be known and practiced in the art. In certain embodiments, measurements may involve proprietary UE signaling facilitating the host computer's 1610 measurements of throughput, propagation times, latency and the like. The measurements may be implemented in that the software 1611, 1631 causes messages to be transmitted, in particular empty or “dummy” messages, using the OTT connection 1650 while it monitors propagation times, errors etc.

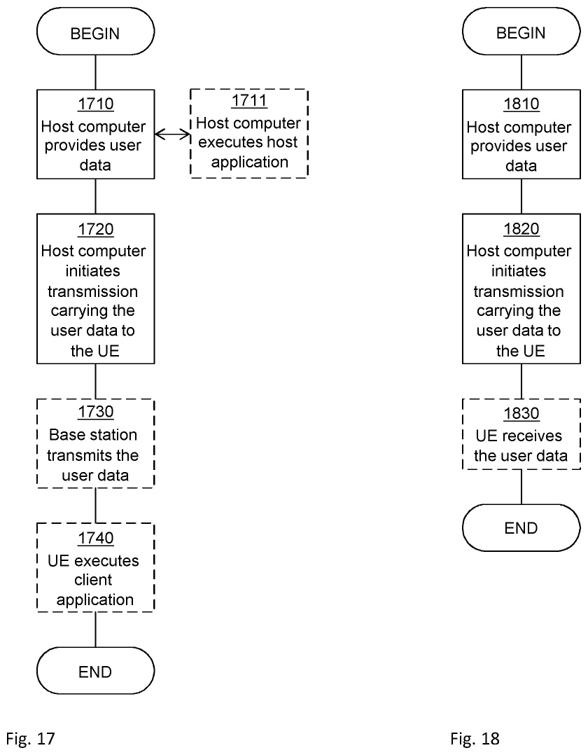

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this paragraph. In a first step 1710 of the method, the host computer provides user data. In an optional substep 1711 of the first step 1710, the host computer provides the user data by executing a host application. In a second step 1720, the host computer initiates a transmission carrying the user data to the UE. In an optional third step 1730, the base station transmits to the UE the user data which was carried in the transmission that the host computer initiated, in accordance with the teachings of the embodiments described throughout this disclosure. In an optional fourth step 1740, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this paragraph. In a first step 1810 of the method, the host computer provides user data. In an optional substep (not shown) the host computer provides the user data by executing a host application. In a second step 1820, the host computer initiates a transmission carrying the user data to the UE. The transmission may pass via the base station, in accordance with the teachings of the embodiments described throughout this disclosure. In an optional third step 1830, the UE receives the user data carried in the transmission.

As has become apparent from above description, at least some embodiments of the technique achieve the one or more of the following goals. A first goal is to addressing or solve the issue of channel unavailability in unlicensed spectrum. A second goal is to improving PSFCH reliability (e.g., mitigate the issue of PSFCH dropping due to prioritization). A third goal is to allowing maximal reuse of the existing NR SL procedures for PSFCH transmission.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the claims.

Moreover, this application discloses, alone and in combination with the above description, the following embodiments.

### List of Embodiments

1. A method (300) performed by a first wireless device (100; 1300; 1591; 1592; 1630) for transmitting a feedback message on a sidelink, SL, to a second wireless device (200; 1400; 1591; 1592; 1630), the method (300) comprising:
responsive to a first time resource (602) for data reception, transmitting (304) a feedback message using a second time resource (604) out of at least two time resource candidates (606) of a feedback channel from the first wireless device (100; 1300; 1591; 1592; 1630) to the second wireless device (200; 1400; 1591; 1592; 1630) on the SL, wherein the at least two time resource candidates (606) are associated to the first time resource (602) according to a temporal relation (608) between the first time resource (602) and each of the time resource candidates (606).

2. The method (300) of embodiment 1, further comprising for the data reception:
receiving (302) or attempting to receive (302) the data in the first time resource (602) of a data channel from the second wireless device (200; 1400; 1591; 1592; 1630) at the first wireless device (100; 1300; 1591; 1592; 1630) on the SL.

3. The method (300) of embodiment 1 or 2, wherein the feedback message is indicative of at least one of:
an acknowledgement, ACK, of the data;
a negative acknowledgement, NACK, of the data; and
a hybrid automatic repeat request, HARQ, feedback for the data.

4. The method (300) of any one of embodiments 1 to 3, wherein the transmitting (304) of the feedback message further comprises:
determining the second time resource (604) out of the at least two time resource candidates (606).

5. The method (300) of any one of embodiments 1 to 4, wherein the transmitting (304) of the feedback message comprises transmitting (304) the feedback message multiple times using multiple second time resources (604) out of the at least two time resource candidates (606).

6. The method (300) of embodiment 4 or 5, wherein the second time resource (604) is determined out of the at least two time resource candidates (606) and/or a number of the one or multiple second time resources (606) used for the transmitting (304) of the feedback message one or multiple times is dependent on one or a combination of:
a priority of the data or a service underlying the data;
the SL between the first wireless device (100; 1300; 1591; 1592; 1630) and the second wireless device (200; 1400; 1591; 1592; 1630) or the pair of the first wireless device (100; 1300; 1591; 1592; 1630) and the second wireless device (200; 1400; 1591; 1592; 1630);
the first time resource (602) or the time when the data is received (302) or attempted to be received (302);
the second wireless device (200; 1400; 1591; 1592; 1630) from which the data is received (302) or attempted to be received (302);
a remaining time of a packet delay budget, PDB, of the data or a service underlying the data; and
a number of remaining time resource candidates that are associated with the first time resource.

7. The method (300) of any one of embodiments 1 to 6, further comprising or wherein receiving (302) or attempting to receive (302) the data comprises at least one of:
receiving (302) or attempting to receive (302) first data in an earlier first time resource (602) and second data in a later first time resource (602) of the data channel;
receiving (302) or attempting to receive (302) first data in a first frequency resource and second data in a second frequency resource of the data channel;
receiving (302) or attempting to receive (302) first data and second data, wherein the priority of the first data is greater than the priority of the second data; and
receiving (302) or attempting to receive (302) first data from the second wireless device (200; 1400; 1591; 1592; 1630) and second data from a further second wireless device (200; 1400; 1591; 1592; 1630).

8. The method (300) of embodiment 7, wherein each of the respective first time resources (602) for the first and second data is associated with the same at least two time resource candidates (606) according to the temporal relation (608), and wherein the transmitting (304) of the feedback message comprises transmitting (304) a first feedback message for the first data in an earlier second time resource (604) out of the at least two time resource candidates (606) and transmitting (304) a second feedback message for the second data in a later second time resource (604) out of the at least two time resource candidates (606).

9. The method (300) of embodiment 7 or 8, wherein each of the respective first time resources (602) for the first and second data is associated with at least one common time resource candidate out of the respective at least two time resource candidates (606) according to the temporal relation (608), and wherein the transmitting (304) of the feedback message comprises transmitting (304) in the common time resource candidate the feedback message for either the first data or the second data depending on which one has the fewer number of remaining time resource candidates after the common time resource candidate out of the respective at least two time resource candidates (606).

10. The method (300) of any one of embodiments 1 to 9, wherein receiving (302) or attempting to receive (302) the data comprises receiving (302) or attempting to receive (302) first data in an earlier first time resource (602) and second data in a later first time resource (602) of the data channel, and
wherein the priority of the second data is greater than the priority of the first data.

11. The method (300) of embodiment 10, wherein each of the earlier first time resource (602) and the later first time resource (602) is associated with the at least two time resource candidates (606) according to the temporal relation (608), and wherein the transmitting (304) of the feedback message comprises transmitting (304) a second feedback message for the second data in an earlier second time resource (604) out of the at least two time resource candidates (606) and transmitting (304) a first feedback message for the first data in a later second time resource (604) out of the at least two time resource candidates (606).

12. The method (300) of any one of embodiments 1 to 11, wherein at least one of the SL, the receiving (302) of the data or the attempting to receive (302) the data, and the transmitting (304) of the feedback message uses radio spectrum shared by multiple radio access technologies, RATs.

13. The method (300) of any one of embodiments 1 to 12, wherein the transmitting (304) of the feedback message comprises:
sensing if the feedback channel is available at an earlier time resource candidate (606) out of the at least two time resource candidates (606),
wherein the feedback message is transmitted (304) using the earlier time resource candidate (606) as the second time resource (604) if a result of the sensing is indicative of the feedback channel being available at the earlier time resource candidate (606), and/or wherein the feedback message is transmitted using a later time resource candidate (606) as the second time resource (604) out of the at least two time resource candidates (606) if a result of the sensing is indicative of the feedback channel being not available at the earlier time resource candidate (606).

14. The method (300) of embodiment 13, wherein the sensing is based on decoding and/or detecting sidelink control information, SCI, from the second wireless device (200; 1400; 1591; 1592; 1630) or a third wireless device to determine if the feedback channel is available at the earlier time resource candidate (606).

15. The method (300) of embodiment 13 or 14, wherein the sensing comprises performing a clear channel assessment, CCA, of the feedback channel for an earlier second time resource (604) out of the at least two time resource candidates (606).

16. The method (300) of any one of embodiments 1 to 15, wherein the at least two time resource candidates (606) are a subset of a set of time resources of the feedback channel, and/or
wherein the at least two time resource candidates (606) are consecutive time resources in a set of time resources of the feedback channel.

17. The method (300) of embodiment 16, wherein the set of time resources of the feedback channel comprises periodically occurring time resources with a periodicity N in units of a length of each time resource, and/or
wherein every N-th time resource of the SL is a time resource of the feedback channel, wherein N is an integer equal to 1 or greater than 1.

18. The method (300) of any one of embodiments 1 to 17, wherein the at least two time resource candidates (606) associated to the first time resource (602) according to the temporal relation (608) comprise time resources of the feedback channel that:
are at least a predefined duration Tₚ later than the first time resource (602), and/or
are at most a predefined time Tₘₐₓ later than the first time resource (602), and/or
include a predefined number of K time resources of the feedback channel, wherein K>1 is an integer, optionally wherein the K time resources of the feedback channel are K consecutive time resources of the feedback channel.

19. The method (300) of any one of embodiments 1 to 18, wherein each of the at least two time resource candidates (606) is associated to the first time resource (602) according to the temporal relation (608) if at least one of:
the respective time resource candidate is a time resource of the feedback channel that is at least a predefined duration Tₚ later than the first time resource (602); and
the respective time resource candidate is a time resource of the feedback channel that is at most a predefined time Tₘₐₓ later than the first time resource (602), optionally wherein Tₘₐₓ=Tₚ+T for T>0.

20. The method (300) of any one of embodiments 1 to 19, further comprising determining a configuration and/or receiving a configuration message indicative of a configuration from a radio access network, RAN (500), or from a network node (300) serving the first wireless device (100; 1300; 1591; 1592; 1630) or from the second wireless device (200; 1400; 1591; 1592; 1630), the configuration being indicative of at least one of:
the first time resource (602) for receiving (302) or attempting to receive (302) the data, optionally in SL control information, SCI;
a set of the time resources of the feedback channel, optionally a periodicity of a physical SL feedback channel, PSFCH;
the parameter N of the set of the time resources of the feedback channel;
the temporal relation (608);
the parameter Tₘₐₓ of the temporal relation (608);
the parameter Tₚ of the temporal relation (608);
the parameter T of the temporal relation (608);
the parameter K of the temporal relation (608); and
a resource pool of the SL, optionally the resource pool comprising the first time resource (602) for the receiving (302) or the attempting to receive (302) the data and the set of the time resources of the feedback channel.

21. The method (300) of any one of embodiments 18 to 20, wherein the configuration, optionally the parameter K and/or the parameter T, depends on or is determined by at least one of:
an interference condition to the SL, optionally an interference condition at the first wireless device (100; 1300; 1591; 1592; 1630) and/or at the second wireless device (200; 1400; 1591; 1592; 1630);
a quality of service, QoS, an interference condition, a latency requirement or a packet delay budget, PDB, of the data or a service using the SL; a numerology to be used on the SL;
an upper bound of the number of physical resource blocks, PRBs, available for the feedback channel;
a priority associated with the data or a service using the SL;
a resource pool or a resource pool configuration of the SL;
contents of the data;
22. The method (300) of any one of embodiments 18 to 21, wherein an indicator, optionally the priority, associated with the data and/or indicated by the SCI scheduling the data reception is indicative of the parameter K and/or the parameter T,
optionally wherein an upper bound of the parameter K and/or the parameter T is predefined per resource pool, and wherein the indicator is indicative of the parameter K and/or the parameter T provided that the indicated value is less than or equal to the predefined upper bound.

23. The method (300) of any one of embodiments 18 to 22, wherein a receiver value of the parameter K and/or the parameter T, or an upper bound thereof, is predefined per resource pool at the first wireless device (100; 1300; 1591; 1592; 1630), and/or
wherein a transmitter value of the parameter K and/or the parameter T is related to contents of the data and/or is known at the second wireless device (200; 1400; 1591; 1592; 1630) and/or is unknown at the first wireless device (100; 1300; 1591; 1592; 1630), and wherein the second wireless device (200; 1400; 1591; 1592; 1630) retransmits the data upon expiry of transmitter value,
optionally wherein the transmitter value is equal to or less than the receiver value.

24. The method (300) of any one of embodiments 1 to 23, wherein frequency resources at the second time resource (604) in the feedback channel, optionally one or more physical resource blocks, PRBs, used for the transmitting (304) of the feedback message depend on the first time resource, and/or
wherein non-overlapping sets of time resources of the data channel for the first time resource (602) are mapped to different frequency resources at the second time resource (604) in the feedback channel, optionally one or more physical resource blocks, PRBs, used for the transmitting (304) of the feedback message.

25. The method (300) of any one of embodiments 1 to 24, wherein different codes, optionally different values of cyclic shifts and/or cyclic shift pairs, are used for the transmitting (304) of the feedback message at the second time resource (604) in the feedback channel depending on the first time resource and/or depending on the second time resource (604) out of at least two time resource candidates (606).

26. The method (300) of any one of embodiments 1 to 25, wherein at least one of:
the feedback channel on the SL is a physical SL feedback channel, PSFCH;
the data channel is a physical SL shared channel, PSSCH;
the second time resource (604) is a slot, optionally a slot of a or the PSFCH;
the earlier and the later second time resource (604)s are earlier and later slots, respectively, optionally earlier and later slots, respectively, of a or the PSFCH;
the at least two time resource candidates (606) of a feedback channel or any time resources of the feedback channel are slots, optionally slots of a or the PSFCH;
the feedback channel comprises in the respective second time resource (604) and/or in each of the at least two time resource candidates (606) one or two or few symbols, optionally consecutive symbols at the end of the respective second time resource (604) and/or the end of each of the at least two time resource candidates (606);
the first time resource (602) for receiving (302) or attempting to receive (302) the data is a first slot used for receiving (302) or attempting to receive (302) the data;
the second time resource (604) used for the transmitting (304) of the feedback message is a second slot used for the transmitting (304) of the feedback message; and
the at least two time resource candidates (606) of a feedback channel are at least two slot candidates of a feedback channel.

27. A method (400) performed by a second wireless device (200; 1400; 1591; 1592; 1630) for receiving a feedback message on a sidelink, SL, from a first wireless device (100; 1300; 1591; 1592; 1630), the method (400) comprising:
responsive to a data transmission using a first time resource (602), receiving (404) a feedback message in a second time resource (604) out of at least two time resource candidates (606) of a feedback channel from the first wireless device (100; 1300; 1591; 1592; 1630) at the second wireless device (200; 1400; 1591; 1592; 1630) on the SL, wherein the at least two time resource candidates (606) are associated to the first time resource (602) according to a temporal relation (608) between the first time resource (602) and each of the time resource candidates (606).

28. The method (400) of embodiment 27, further comprising for the data transmission:
transmitting (402) the data using the first time resource (602) of a data channel on the SL from the second wireless device (200; 1400; 1591; 1592; 1630) to the first wireless device (100; 1300; 1591; 1592; 1630).

29. The method (400) of embodiment 27 or 28, further comprising any one of the features or steps of any one of the embodiments 1 to 26, or a feature or step corresponding thereto.

30. A computer program product comprising program code portions for performing the steps of any one of the embodiments 1 to 26 or 27 to 29 when the computer program product is executed on one or more computing devices (1304; 1404), optionally stored on a computer-readable recording medium (1306; 1406).

31. A first wireless device (100; 1300; 1591; 1592; 1630) for transmitting a feedback message on a sidelink, SL, to a second wireless device (200; 1400; 1591; 1592; 1630), the first wireless device (100; 1300; 1591; 1592; 1630) comprising memory operable to store instructions and processing circuitry operable to execute the instructions, such that the first wireless device (100; 1300; 1591; 1592; 1630) is operable to:
responsive to a first time resource (602) for data reception, transmit a feedback message using a second time resource (604) out of at least two time resource candidates (606) of a feedback channel from the first wireless device (100; 1300; 1591; 1592; 1630) to the second wireless device (200; 1400; 1591; 1592; 1630) on the SL, wherein the at least two time resource candidates (606) are associated to the first time resource (602) according to a temporal relation (608) between the first time resource (602) and each of the time resource candidates (606).

32. The first wireless device (100; 1300; 1591; 1592; 1630) of embodiment 31, further operable to perform the steps of any one of embodiments 2 to 26.

33. A first wireless device (100; 1300; 1591; 1592; 1630) for transmitting a feedback message on a sidelink, SL, to a second wireless device (200; 1400; 1591; 1592; 1630), the first wireless device (100; 1300; 1591; 1592; 1630) being configured to:
responsive to a first time resource (602) for data reception, transmit a feedback message using a second time resource (604) out of at least two time resource candidates (606) of a feedback channel from the first wireless device (100; 1300; 1591; 1592; 1630) to the second wireless device (200; 1400; 1591; 1592; 1630) on the SL, wherein the at least two time resource candidates (606) are associated to the first time resource (602) according to a temporal relation (608) between the first time resource (602) and each of the time resource candidates (606).

34. The first wireless device (100; 1300; 1591; 1592; 1630) of embodiment 33, further configured to perform the steps of any one of embodiments 2 to 26.

35. A receiving user equipment, UE (100; 1300; 1591; 1592; 1630), for transmitting a feedback message on a sidelink, SL, to a transmitting UE (200; 1400; 1591; 1592; 1630), the receiving UE (100; 1300; 1591; 1592; 1630) being configured to communicate with a base station (300; 1512; 1620) and/or a peer UE, the receiving UE (100; 1300; 1591; 1592; 1630) comprising a radio interface (1302; 1637) and processing circuitry (1304; 1638) configured to:
responsive to a first time resource (602) for data reception, transmit a feedback message using a second time resource (604) out of at least two time resource candidates (606) of a feedback channel from the receiving UE (100; 1300; 1591; 1592; 1630) to the transmitting UE (200; 1400; 1591; 1592; 1630) on the SL, wherein the at least two time resource candidates (606) are associated to the first time resource (602) according to a temporal relation (608) between the first time resource (602) and each of the time resource candidates (606).

36. The receiving UE (100; 1300; 1591; 1592; 1630) of embodiment 30, wherein the processing circuitry (1304; 1638) is further configured to execute the steps of any one of embodiments 2 to 26.

37. A second wireless device (200; 1400; 1591; 1592; 1630) for receiving a feedback message on a sidelink, SL, from a first wireless device (100; 1300; 1591; 1592; 1630), the second wireless device (200; 1400; 1591; 1592; 1630) comprising memory operable to store instructions and processing circuitry operable to execute the instructions, such that the second wireless device (200; 1400; 1591; 1592; 1630) is operable to:
responsive to a data transmission using a first time resource (602), receive a feedback message in a second time resource (604) out of at least two time resource candidates (606) of a feedback channel from the first wireless device (100; 1300; 1591; 1592; 1630) at the second wireless device (200; 1400; 1591; 1592; 1630) on the SL, wherein the at least two time resource candidates (606) are associated to the first time resource (602) according to a temporal relation (608) between the first time resource (602) and each of the time resource candidates (606).

38. The second wireless device (200; 1400; 1591; 1592; 1630) of embodiment 32, further operable to perform the steps of any one of embodiments 27 to 29.

39. A second wireless device (200; 1400; 1591; 1592; 1630) for receiving a feedback message on a sidelink, SL, from a first wireless device (100; 1300; 1591; 1592; 1630), the second wireless device (200; 1400; 1591; 1592; 1630) being configured to:
responsive to a data transmission using a first time resource (602), receive a feedback message in a second time resource (604) out of at least two time resource candidates (606) of a feedback channel from the first wireless device (100; 1300; 1591; 1592; 1630) at the second wireless device (200; 1400; 1591; 1592; 1630) on the SL, wherein the at least two time resource candidates (606) are associated to the first time resource (602) according to a temporal relation (608) between the first time resource (602) and each of the time resource candidates (606).

40. The second wireless device (200; 1400; 1591; 1592; 1630) of embodiment 39, further configured to perform the steps of any one of embodiments 27 to 29.

41. A transmitting user equipment, UE (200; 1400; 1591; 1592; 1630), for receiving a feedback message on a sidelink, SL, from a receiving UE (100; 1300; 1591; 1592; 1630), the transmitting UE (200; 1400; 1591; 1592; 1630) being configured to communicate with a base station (300; 1512; 1620) and/or a peer UE, the transmitting UE (200; 1400; 1591; 1592; 1630) comprising a radio interface (1402; 1637) and processing circuitry (1404; 1638) configured to:
responsive to a data transmission using a first time resource (602), receive a feedback message in a second time resource (604) out of at least two time resource candidates (606) of a feedback channel from the receiving UE (100; 1300; 1591; 1592; 1630) at the transmitting UE (200; 1400; 1591; 1592; 1630) on the SL, wherein the at least two time resource candidates (606) are associated to the first time resource (602) according to a temporal relation (608) between the first time resource (602) and each of the time resource candidates (606).

42. The transmitting UE (200; 1400; 1591; 1592; 1630) of embodiment 41, wherein the processing circuitry (1404; 1638) is further configured to execute the steps of any one of embodiments 27 to 29.

43. A communication system (1500; 1600) including a host computer (1330; 1410) comprising:
processing circuitry (1618) configured to provide user data; and
a communication interface (1616) configured to forward user data to a cellular or ad hoc radio network (1510) for transmission to a transmitting or receiving user equipment, UE (100; 200; 1300; 1400; 1591; 1592; 1630), wherein the UE (100; 200; 1300; 1400; 1591; 1592; 1630) comprises a radio interface (1102; 1437) and processing circuitry (1104; 1438), the processing circuitry (1104; 1438) of the UE (100; 200; 1300; 1400; 1591; 1592; 1630) being configured to execute the steps of any one of embodiments 1 to 21 and/or 22 to 24.

44. The communication system (1500; 1600) of embodiment 43, further including at least one of the transmitting and receiving UE (100; 200; 1300; 1400; 1591; 1592; 1630).

45. The communication system (1500; 1600) of embodiment 43 or 44, wherein the radio network (1310) further comprises a base station (300; 1512; 1620), or a radio device (100; 200; 1300; 1400; 1591; 1592; 1630) functioning as a gateway, which is configured to communicate with the transmitting or receiving UE (100; 200; 1300; 1400; 1591; 1592; 1630).

46. The communication system (1500; 1600) of embodiment 45, wherein the base station (300; 1512; 1620), or the radio device (100; 200; 1300; 1400; 1591; 1592; 1630) functioning as a gateway, comprises processing circuitry (1628), which is configured to control or configure the steps of embodiments 1 to 21 or 22 to 24.

47. The communication system (1500; 1600) of any one of embodiments 43 to 46, wherein:
the processing circuitry (1618) of the host computer (1530; 1610) is configured to execute a host application (1612), thereby providing the user data; and
the processing circuitry (1304; 1404; 1638) of the UE (100; 200; 1300; 1400; 1591; 1592; 1630) is configured to execute a client application (1632) associated with the host application (1612).

1.-47. (canceled)

48. A method performed by a first wireless device for transmitting a feedback message on a sidelink (SL) to a second wireless device, the method comprising:
responsive to data reception or attempted data reception using a first time resource, transmitting the feedback message using a second time resource out of at least two time resource candidates of a feedback channel from the first wireless device to the second wireless device on the SL,
wherein each of the at least two time resource candidates is associated to the first time resource according to a temporal relation.

49. The method of claim 48, wherein at least one of the SL and the transmission of the feedback message uses radio spectrum shared by multiple radio access technologies.

50. The method of claim 48, wherein transmitting the feedback message comprises sensing whether the feedback channel is available at an earlier time resource candidate out of the at least two time resource candidates, wherein one or more of the following applies:
the feedback message is transmitted using the earlier time resource candidate as the second time resource when a result of the sensing indicates the feedback channel being available at the earlier time resource candidate, and
the feedback message is transmitted using a later time resource candidate as the second time resource out of the at least two time resource candidates when a result of the sensing indicates the feedback channel being not available at the earlier time resource candidate.

51. The method of claim 48, wherein one or more of the following applies:
the at least two time resource candidates are a subset of a set of time resources of the feedback channel; and
the at least two time resource candidates are consecutive time resources in a set of time resources of the feedback channel.

52. The method of claim 51, wherein one or more of the following applies:
the set of time resources of the feedback channel comprises periodically occurring time resources with a periodicity N in units of a length of each time resource; and
every N-th time resource of the SL is a time resource of the feedback channel, wherein N is an integer greater than or equal to one.

53. The method of claim 48, wherein one or more of the following applies:
each of the at least two time resource candidates is associated to the first time resource according to one or more of the following temporal relations:
are at least a predefined duration Tₚ later than the first time resource, and
are at most a predefined time Tₘₐₓ later than the first time resource; and
the at least two time resource candidates are among a predefined integer number K consecutive time resources of the feedback channel, wherein K is greater than one.

54. The method of claim 48, further comprising determining or receiving a configuration indicative of at least one of the following:
the first time resource;
the time resources of the feedback channel;
a periodicity of the time resources of the feedback channel;
one or more parameters that define the temporal relation;
an integer K that identifies a number of consecutive time resources of the feedback channel; and
a SL resource pool that includes one or more of the following: the first time resource, and the time resources of the feedback channel.

55. The method of claim 53, wherein:
the integer K is indicated by one or more of the following: an indicator associated with the data, and SL control information (SCI) scheduling the data reception; and
one or more of the following applies:
the indication of K is further indicative of a parameter T related to a time span of the at least two time resource candidates of the feedback channel;
the indication of K is a priority associated with the data; and
an upper bound of at least one of K and the parameter T is predefined per resource pool, and the indication of K is further indicative of the parameter T when the indicated value of K is less than or equal to the predefined upper bound.

56. A method performed by a second wireless device for receiving a feedback message on a sidelink (SL) from a first wireless device, the method comprising:
responsive to a data transmission using a first time resource, receiving a feedback message in a second time resource out of at least two time resource candidates of a feedback channel from the first wireless device at the second wireless device on the SL,
wherein each of the at least two time resource candidates is associated to the first time resource according to a temporal relation.

57. The method of claim 56, wherein at least one of the SL and the reception of the feedback message uses radio spectrum shared by multiple radio access technologies.

58. The method of claim 56, wherein one or more of the following applies:
the at least two time resource candidates are a subset of a set of time resources of the feedback channel; and
the at least two time resource candidates are consecutive time resources in a set of time resources of the feedback channel.

59. The method of claim 58, wherein one or more of the following applies:
the set of time resources of the feedback channel comprises periodically occurring time resources with a periodicity N in units of a length of each time resource; and
every N-th time resource of the SL is a time resource of the feedback channel, wherein N is an integer greater than or equal to one.

60. The method of claim 56, wherein one or more of the following applies:
each of the at least two time resource candidates is associated to the first time resource according to one or more of the following temporal relations:
are at least a predefined duration Tₚ later than the first time resource, and
are at most a predefined time Tₘₐₓ later than the first time resource; and
the at least two time resource candidates are among a predefined integer number K consecutive time resources of the feedback channel, wherein K is greater than one.

61. The method of claim 56, further comprising determining or receiving a configuration indicative of at least one of the following:
the first time resource;
the time resources of the feedback channel;
a periodicity of the time resources of the feedback channel;
one or more parameters that define the temporal relation;
an integer K that identifies a number of consecutive time resources of the feedback channel; and
a SL resource pool that includes one or more of the following: the first time resource, and the time resources of the feedback channel.

62. The method of claim 60, wherein:
the integer K is indicated by one or more of the following: an indicator associated with the data, and SL control information (SCI) scheduling the data reception; and
one or more of the following applies:
the indication of K is further indicative of a parameter T related to a time span of the at least two time resource candidates of the feedback channel;
the indication of K is a priority associated with the data; and
an upper bound of at least one of K and the parameter T is predefined per resource pool, and the indication of K is further indicative of the parameter T when the indicated value of K is less than or equal to the predefined upper bound.

63. A non-transitory, computer-readable medium having stored thereon instructions that, when executed by processing circuitry of a first wireless device, cause the first wireless device to perform the method of claim 48.

64. A non-transitory, computer-readable medium having stored thereon instructions that, when executed by processing circuitry of a second wireless device, cause the second wireless device to perform the method of claim 56.

65. A first wireless device configured to transmit a feedback message on a sidelink (SL) to a second wireless device, the first wireless device comprising:
memory operable to store instructions; and
processing circuitry operable to execute the instructions, wherein execution of the instructions causes the first wireless device to:
responsive to data reception or attempted data reception using a first time resource, transmit the feedback message using a second time resource out of at least two time resource candidates of a feedback channel from the first wireless device to the second wireless device on the SL,
wherein each of the at least two time resource candidates is associated to the first time resource according to a temporal relation.

66. The first wireless device of claim 65, wherein execution of the instructions causes the first wireless device to transmit the feedback message based on sensing whether the feedback channel is available at an earlier time resource candidate out of the at least two time resource candidates, and wherein one or more of the following applies:
the feedback message is transmitted using the earlier time resource candidate as the second time resource when a result of the sensing indicates the feedback channel being available at the earlier time resource candidate, and
the feedback message is transmitted using a later time resource candidate as the second time resource out of the at least two time resource candidates when a result of the sensing indicates the feedback channel being not available at the earlier time resource candidate.

67. The first wireless device of claim 65, wherein one or more of the following applies:
the at least two time resource candidates are a subset of a set of time resources of the feedback channel,
the at least two time resource candidates are consecutive time resources in a set of time resources of the feedback channel,
the set of time resources of the feedback channel comprises periodically occurring time resources with a periodicity N in units of a length of each time resource, and
every N-th time resource of the SL is a time resource of the feedback channel, wherein N is an integer greater than or equal to one.

68. The first wireless device of claim 65, wherein one or more of the following applies:
each of the at least two time resource candidates is associated to the first time resource according to one or more of the following temporal relations:
are at least a predefined duration Tₚ later than the first time resource, and
are at most a predefined time Tₘₐₓ later than the first time resource; and
the at least two time resource candidates are among a predefined integer number K consecutive time resources of the feedback channel, wherein K is greater than one.

69. The first wireless device of claim 65, wherein execution of the instructions further causes the first wireless device to determine or receive a configuration indicative of at least one of the following:
the first time resource;
the time resources of the feedback channel;
a periodicity of the time resources of the feedback channel;
one or more parameters that define the temporal relation;
an integer K that identifies a number of consecutive time resources of the feedback channel; and
a SL resource pool that includes one or more of the following: the first time resource, and the time resources of the feedback channel.

70. A second wireless device configured to receive a feedback message on a sidelink (SL) from a first wireless device, the second wireless device comprising:
memory operable to store instructions, and
processing circuitry operable to execute the instructions, wherein execution of the instructions causes the first wireless device to:
responsive to a data transmission using a first time resource, receive a feedback message in a second time resource out of at least two time resource candidates of a feedback channel from the first wireless device at the second wireless device on the SL,
wherein each of the at least two time resource candidates is associated to the first time resource according to a temporal relation.

71. The second wireless device of claim 70, wherein one or more of the following applies:
the at least two time resource candidates are a subset of a set of time resources of the feedback channel,
the at least two time resource candidates are consecutive time resources in a set of time resources of the feedback channel,
the set of time resources of the feedback channel comprises periodically occurring time resources with a periodicity N in units of a length of each time resource, and
every N-th time resource of the SL is a time resource of the feedback channel, wherein N is an integer greater than or equal to one.

72. The second wireless device of claim 70, wherein one or more of the following applies:
each of the at least two time resource candidates is associated to the first time resource according to one or more of the following temporal relations:
are at least a predefined duration Tₚ later than the first time resource, and
are at most a predefined time Tₘₐₓ later than the first time resource; and
the at least two time resource candidates are among a predefined integer number K consecutive time resources of the feedback channel, wherein K is greater than one.

73. The second wireless device of claim 70, wherein execution of the instructions further causes the second wireless device to determine or receive a configuration indicative of at least one of the following:
the first time resource;
the time resources of the feedback channel;
a periodicity of the time resources of the feedback channel;
one or more parameters that define the temporal relation;
an integer K that identifies a number of consecutive time resources of the feedback channel; and
a SL resource pool that includes one or more of the following: the first time resource, and the time resources of the feedback channel.
